(19) United States
(12) Patent Application Publication
(10) Pub. No.: US 2017/0214939 A1
(43) Pub. Date: Jul. 27, 2017

(54) METHOD AND APPARATUS FOR ENCODING OR DECODING DEPTH IMAGE

(71) Applicant: SAMSUNG ELECTRONICS CO., LTD., Suawon-si (KR)

(72) Inventors: Jin-young LEE, Suwon-si (KR); Min-woo PARK, Yongin-si (KR); Yong-jin CHO, Seoul (KR)

(73) Assignee: SAMSUNG ELECTRONICS CO., LTD., Suwon-si (KR)

(21) Appl. No.: 15/300,841

(22) PCT Filed: Mar. 31, 2015
(86) PCT No.: PCT/KR2015/003166

§ 371 Date: Sep. 30, 2016

Related U.S. Application Data
(60) Provisional application No. 61/972,695, filed on Mar. 31, 2014.

(51) Int. Cl. H04N 19/593; H04N 19/105; H04N 19/159; H04N 19/46

(52) U.S. Cl. CPC H04N 19/593; H04N 19/46; H04N 19/105; H04N 19/159; H04N 19/184

(57) ABSTRACT

A depth image decoding method according to an embodiment may include obtaining, from a bitstream, a first flag including information about use of an intra contour mode related to intra prediction of a depth image, determining whether to perform prediction in the intra contour mode on a prediction unit of the depth image, based on the first flag, performing prediction in the intra contour mode on the prediction unit upon determining to perform prediction in the intra contour mode on the prediction unit, and decoding the depth image based on a result of the performing of prediction.

### TECHNICAL FIELD

The present invention relates to a method and apparatus for defining a flag and a new intra slice type to allow a depth intra slice related to a depth image to refer to a color intra slice related to a color image in a three-dimensional (3D) video.

### BACKGROUND ART

Due to development of digital video processing and computer graphic technologies, research is being actively conducted on 3D and multi-view video technologies for reproducing the real world and allowing users to experience the same. A three-dimensional (3D) television using multi-view videos is capable of providing contents obtained by reconfiguring the real world, to give senses of reality to users, and thus attracts much attention as a next-generation broadcast technology. A 3D video coding system supports multi-view videos to be freely viewed in various views by users or to be reproducible in various 3D reproduction apparatuses. A depth image used in a multi-view video may be generated with reference to information included in a color image corresponding to the depth image.

### DETAILED DESCRIPTION OF THE INVENTION

### Technical Problem

The present invention defines a flag indicating that a depth intra slice refers to a color intra slice, and provides a slice type for defining a depth intra slice capable of referring to a color intra slice.

### Technical Solution

According to an aspect of the present invention, a depth image decoding method includes obtaining a first flag including information about use of an intra contour mode related to intra prediction of a depth image, from a bitstream, determining whether to perform prediction in the intra contour mode on a prediction unit of the depth image, based on the first flag, performing prediction in the intra contour mode on the prediction unit upon determining to perform prediction in the intra contour mode on the prediction unit, and decoding the depth image based on a result of the performing of prediction.

### Advantageous Effects of the Invention

When a depth image is decoded or encoded, whether intra contour prediction for referring to a color image is performed on a prediction unit of the depth image may be determined based on a flag related to intra contour prediction, which is included in a slice parameter sequence related to the depth image.

### DESCRIPTION OF THE DRAWINGS

FIG. 1 is a block diagram of a multi-view video system according to an embodiment.

FIG. 2 is a diagram showing texture pictures and depth pictures of a multi-view video.

FIG. 3A is a block diagram of a depth image decoding apparatus.

FIG. 3B is a flowchart of a depth image decoding method according to an embodiment.

FIG. 4A is a block diagram of a depth image encoding apparatus.

FIG. 4B is a flowchart of a depth image encoding method according to an embodiment.

FIG. 5 is a table showing slice_types supported in three-dimensional (3D) high efficiency video coding (HEVC).

FIG. 6A is a table showing syntax for performing coding by determining a prediction mode to be performed on a prediction unit of a current coding unit, according to an embodiment.

FIG. 6B is a table showing an sps_3d_extension( ) including an intra_contour_flag[d], according to an embodiment.

FIG. 6C is a table showing syntax for describing an operation of obtaining a third flag[x0][y0] and a second flag[x0][y0] from a bitstream in an intra_mode_ext(x0, y0, log 2PbSize).

FIG. 7 is a block diagram of a video encoding apparatus based on coding units according to a tree structure, according to an embodiment.

FIG. 8 is a block diagram of a video decoding apparatus based on coding units according to a tree structure, according to an embodiment.

FIG. 9 is a diagram for describing a concept of coding units, according to an embodiment.

FIG. 10 is a block diagram of an image encoder based on coding units, according to an embodiment.

FIG. 11 is a block diagram of an image decoder based on coding units, according to an embodiment.

FIG. 12 is a diagram illustrating coding units according to depths and partitions, according to an embodiment.

FIG. 13 is a diagram for describing a relationship between a coding unit and transformation units, according to an embodiment.

FIG. 14 illustrates a plurality of pieces of encoding information according to depths, according to an embodiment.

FIG. 15 is a diagram of coding units according to depths, according to an embodiment.

FIGS. 16, 17, and 18 are diagrams for describing a relationship between coding units, prediction units, and transformation units, according to an embodiment.

FIG. 19 is a diagram for describing a relationship between a coding unit, a prediction unit, and a transformation unit, according to encoding mode information of Table 1.

FIG. 20 is a diagram of a physical structure of a disc in which a program is stored, according to an embodiment.

FIG. 21 is a diagram of a disc drive for recording and reading a program by using the disc.

FIG. 22 is a diagram of an overall structure of a content supply system for providing a content distribution service.

FIGS. 23 and 24 are diagrams respectively of an external structure and an internal structure of a mobile phone to which a video encoding method and video decoding method of the present disclosure are applied, according to an embodiment.

FIG. 25 is a diagram of a digital broadcasting system to which a communication system according to the present disclosure is applied.

FIG. 26 illustrates a network structure of a cloud computing system using a video encoding apparatus and a video decoding apparatus according to an embodiment.

### BEST MODE

According to an aspect of the present invention, a depth image decoding method includes obtaining, from a bitstream, a first flag including information about use of an intra contour mode related to intra prediction of a depth image, determining whether to perform prediction in the intra contour mode on a prediction unit of the depth image, based on the first flag, performing prediction in the intra contour mode on the prediction unit upon determining to perform prediction in the intra contour mode on the prediction unit, and decoding the depth image based on a result of the performing of prediction.

The first flag may be included in a sequence parameter set extension including additional information for decoding the depth image.

The depth image decoding method may further include reconstructing a color image based on coding information of the color image obtained from the bitstream, splitting a largest coding unit of the depth image into at least one coding unit based on split information of the depth image, determining whether to perform intra prediction on the coding unit, and splitting the coding unit into the prediction unit for prediction decoding. The determining of whether to perform prediction in the intra contour mode may include determining whether a slice type corresponding to the coding unit indicates an intra slice, and the intra slice indicated by the slice type may include an enhanced intra slice allowing prediction on the depth image with reference to the color image.

The performing of prediction may include performing prediction on a prediction unit included in the enhanced intra slice, with reference to a block of the color image included in the same access unit as the depth image.

The determining of whether to perform prediction in the intra contour mode may include obtaining a third flag including information for determining whether to obtain a second flag including information about use of a depth intra mode, from the bitstream, and determining to perform prediction in the depth intra mode, if the third flag has a value 0.

The performing of prediction may include obtaining the second flag from the bitstream if the third flag has a value 0, determining whether the second flag includes information about the intra contour mode, and performing prediction in the intra contour mode on the prediction unit, if the second flag includes the information about the intra contour mode.

The performing of prediction in the intra contour mode may include referring to a block of the color image included in the same access unit as the depth image and provided at a location corresponding to the location of the prediction unit, and performing prediction in the intra contour mode on the prediction unit based on a result of the referring.

According to another aspect of the present invention, a depth image encoding method includes generating a first flag including information about use of an intra contour mode related to intra prediction of a depth image, among intra prediction modes, determining whether to perform prediction in the intra contour mode on a prediction unit of the depth image, based on the first flag, performing prediction in the intra contour mode on the prediction unit upon determining to perform prediction in the intra contour mode on the prediction unit, and encoding the depth image based on a result of the performing of prediction.

The first flag may be included in a sequence parameter set extension including additional information for encoding the depth image.

The depth image encoding method may further include generating a bitstream including coding information generated by encoding a color image, splitting a largest coding unit of the depth image into at least one coding unit, determining whether to perform intra prediction on the coding unit, and splitting the coding unit into the prediction unit for prediction encoding. The determining of whether to perform prediction in the intra contour mode may include determining whether a slice type corresponding to the prediction unit indicates an intra slice, and the intra slice indicated by the slice type may include an enhanced intra slice allowing prediction with reference to the color image.

The performing of prediction may include performing prediction on a prediction unit of the depth image included in the enhanced intra slice, with reference to a block of the color image included in the same access unit as the depth image.

The determining of whether to perform prediction in the intra contour mode may include generating the bitstream including a third flag including information for determining whether to obtain a second flag including information about use of a depth intra contour prediction mode, and determining to perform prediction in the depth intra contour prediction mode, if the third flag has a value 0.

The performing of prediction may include generating the bitstream including the second flag if the third flag has a value 0, determining whether the second flag includes information about the intra contour mode, and performing prediction in the intra contour mode on the prediction unit, if the second flag includes the information about the intra contour mode.

The performing of prediction in the intra contour mode may include referring to a block of the color image included in the same access unit as the depth image and provided at a location corresponding to the location of the prediction unit, and performing prediction in the intra contour mode on the prediction unit based on a result of the referring.

According to another aspect of the present invention, a depth image decoding apparatus includes a depth image prediction mode determiner for obtaining, from a bitstream, a first flag including information about use of an intra contour mode related to intra prediction of a depth image, and determining whether to perform prediction in the intra contour mode on a prediction unit of the depth image, based on the first flag, and a depth image decoder for performing prediction in the intra contour mode on the depth image upon determining to perform prediction in the intra contour mode on the prediction unit, and decoding the depth image based on a result of the performing of prediction.

According to another aspect of the present invention, a depth image encoding apparatus includes a depth image prediction mode determiner for generating a first flag including information about use of an intra contour mode related to intra prediction of a depth image, and determining whether to perform prediction in the intra contour mode on a prediction unit of the depth image, based on the first flag, and a depth image encoder for performing prediction in the intra contour mode on the prediction unit upon determining to perform prediction in the intra contour mode on the prediction unit, and encoding the depth image based on a result of the performing of prediction.

According to another aspect of the present invention, a non-transitory computer-readable recording medium has recorded thereon the above-described depth image decoding method.

According to another aspect of the present invention, a non-transitory computer-readable recording medium has recorded thereon the above-described depth image encoding method.

### MODE OF THE INVENTION

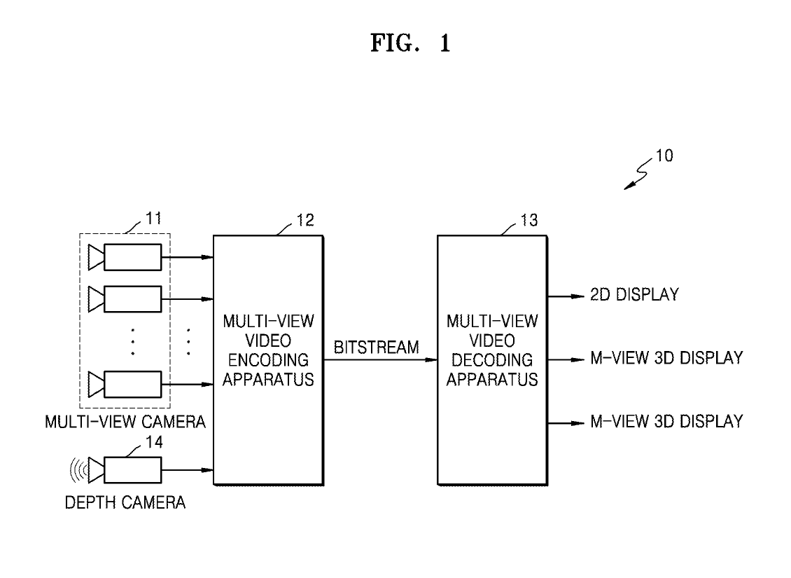

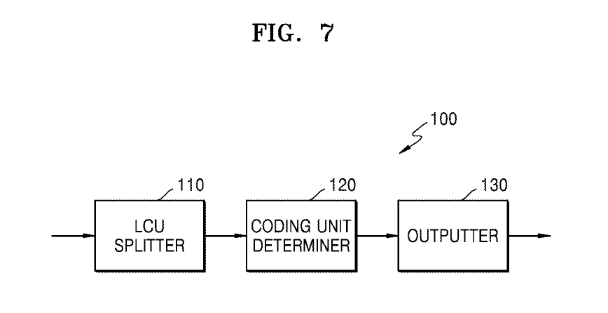

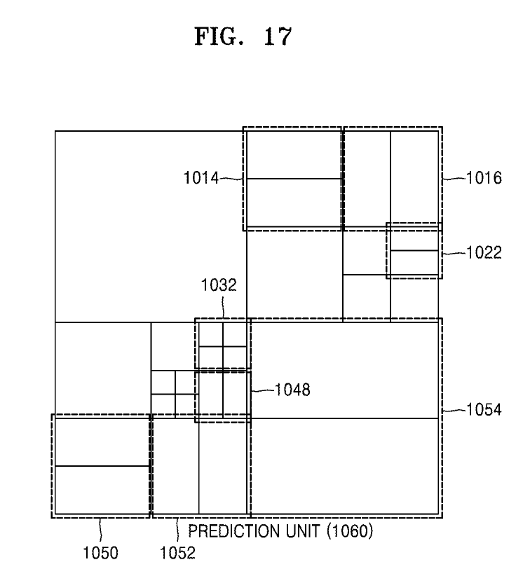

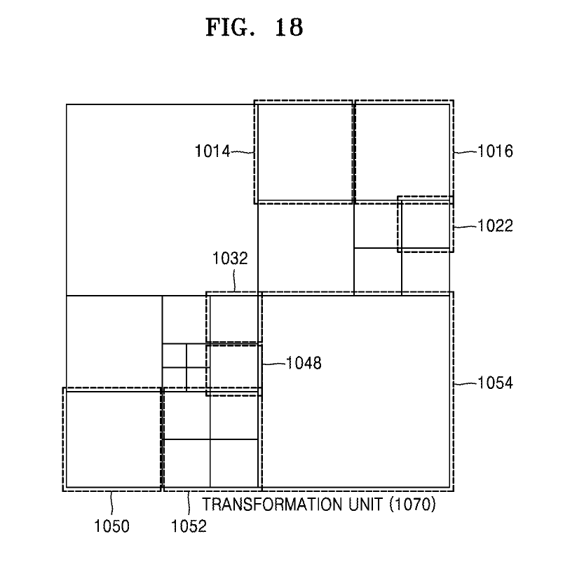

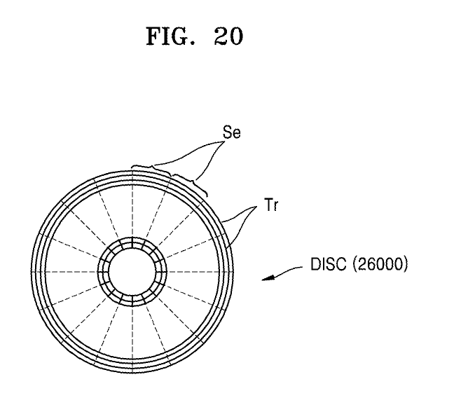

Hereinafter, a depth image decoding method and a depth image encoding method according to embodiments will be described with reference to FIGS. 1 to 6C. In addition, a video encoding method and a video decoding method based on coding units having a tree structure according to embodiments, which are applicable to the above depth image decoding method and the depth image encoding method, will be described with reference to FIGS. 7 to 19. Furthermore, various embodiments applicable to the above video encoding method and the video decoding method will be described with reference to FIGS. 20 to 26.

In the following description, the term ‘image’ may refer to a still image of a video, or a moving image, i.e., the video itself.

The term ‘sample’ refers to data assigned to a sampling location of an image and data to be processed. For example, pixels of an image in the spatial domain may be samples.

The term ‘layer image’ refers to specific-view images or specific-type images. In a multi-view video, a layer image indicates color images or depth images input in a specific view.

FIG. 1 is a block diagram of a multi-view video system 10 according to an embodiment.

The multi-view video system 10 includes a multi-view video encoding apparatus 12 for generating a bitstream by encoding a multi-view video obtained using two or more multi-view cameras 11, a depth image obtained using a depth camera 14 to correspond to the multi-view video, and camera parameters related to the multi-view cameras 11, and a multi-view video decoding apparatus 13 for decoding the bitstream and providing decoded multi-view video frames in a variety of forms upon requests of viewers.

The multi-view cameras 11 include a plurality of cameras of different views and provide multi-view pictures per frame. In the following description, a color image obtained per view according to a predetermined color format, e.g., YUV or YCbCr, may be called a texture image.

The depth camera 14 provides a depth image expressing depth information of a scene as a 256-level 8-bit image. The number of bits for expressing a pixel of the depth image is not limited to 8 and may vary. The depth camera 14 may provide a depth image having a value proportional or inverse-proportional to a distance from the depth camera 14 to an object or a background, which is measured using infrared light or the like. As described above, a single-view video includes a texture image and a depth image.

When the multi-view video encoding apparatus 12 encodes and transmits multi-view texture images and a depth image corresponding thereto, the multi-view video decoding apparatus 13 may not only provide a stereoscopic video or a three-dimensional (3D) video having a three-dimensional effect but also provide a 3D video of a predetermined view desired by a viewer, using the multi-view texture images and the depth image included in the bitstream. A header of the bitstream of the multi-view video data may include information indicating whether information about the depth image is included in data packets, or information about an image type indicating whether each data packet is for a texture image or the depth image. Depending on hardware performance of a receiver, if the depth image is used to reconstruct the multi-view video, the multi-view video decoding apparatus 13 may decode the multi-view video by using the received depth image. If the hardware of the receiver does not support the multi-view video and thus the depth image is not usable, the multi-view video decoding apparatus 13 may discard data packets received in relation to the depth image. As described above, if the multi-view video decoding apparatus 13 of the receiver is not capable of displaying the multi-view video, any single-view video of the multi-view video may be displayed as a two-dimensional (2D) video.

Since the amount of data to be encoded is increased in proportion to the number of views of the multi-view video data and the depth image also needs to be encoded to provide a three-dimensional effect, an enormous amount of multi-view video data should be efficiently compressed to implement the multi-view video system 10 illustrated in FIG. 1.

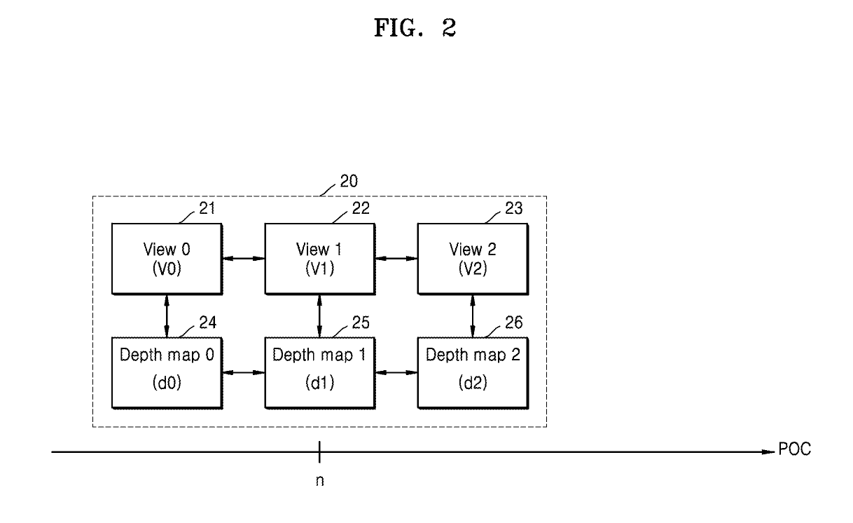

FIG. 2 is a diagram showing texture pictures and depth pictures of the multi-view video.

FIG. 2 illustrates a texture picture v0; 21 of a first view, e.g., view 0, a depth picture d0; 24 corresponding to the texture picture v0; 21 of view 0, a texture picture v1; 22 of a second view, e.g., view 1, a depth picture d1; 25 corresponding to the texture picture v1; 22 of view 1, a texture picture v2; 23 of a third view, e.g., view 2, and a depth picture d2; 26 corresponding to the texture picture v2; 23 of view 2. Although the multi-view texture pictures v0, v1, and v2; 21, 22, and 23 of three views, e.g., view 0, view 1, and view 2, and the depth pictures d0, d1, and d2; 24, 25, and 26 corresponding thereto are illustrated in FIG. 2, the number of views is not limited thereto and may vary. The multi-view texture pictures v0, v1, and v2; 21, 22, and 23 and the depth pictures d0, d1, and d2; 24, 25, and 26 corresponding thereto are obtained at the same timing and thus have the same picture order count (POC). In the following description, a group of pictures (GOP) 20 having the same POC value of n (where n is an integer) like the multi-view texture pictures v0, v1, and v2; 21, 22, and 23 and the depth pictures d0, d1, and d2; 24, 25, and 26 corresponding thereto may be called an n^{th} GOP. A GOP having the same POC may configure an access unit. An encoding order of the access unit does not always need to be the same as a capturing order (obtaining order) or a display order thereof, and may differ therefrom in consideration of relationships of reference.

To specify the view of each texture picture and a depth picture corresponding thereto, a view identifier, e.g., ViewId, which is a view order index may be used. A texture picture and a depth picture of the same view have the same view identifier. The view identifier may be used to determine an encoding order. For example, the multi-view video encoding apparatus 12 may encode the multi-view video in the order from a small value to a large value of the view identifier. That is, the multi-view video encoding apparatus 12 may encode a texture picture and a depth picture having a ViewId of 0, and then encode a texture picture and a depth picture having a ViewId of 1. If the encoding order is determined based on the view identifier, error data received in an environment where errors are easily generated may be identified using the view identifier. However, an encoding or decoding order of pictures of each view may vary irrespectively of the order of a view identifier thereof.

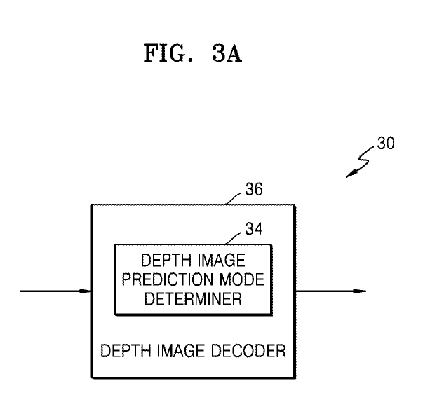

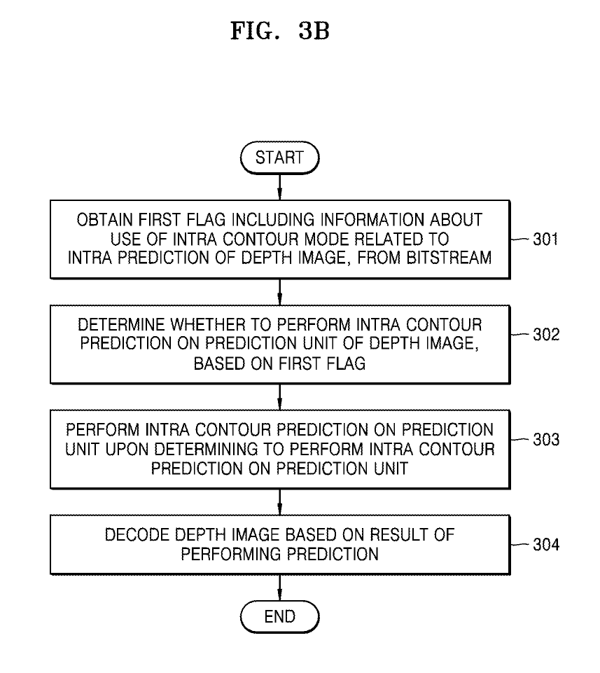

FIG. 3A is a block diagram of a depth image decoding apparatus 30. The depth image decoding apparatus 30 of FIG. 3A may correspond to the multi-view video decoding apparatus 13 of FIG. 1.

Referring to FIG. 3A, a depth image decoder 36 splits a largest coding unit of a depth image into at least one coding unit based on split information of the depth image obtained from a bitstream. The depth image decoder 36 splits the coding unit into at least one prediction unit for prediction decoding. The depth image decoder 36 decodes a current prediction unit by using difference information based on whether the current prediction unit is split into partitions and whether the difference information is used. In this case, the depth image decoder 36 intra-prediction-decodes the current prediction unit by using the difference information.

The depth image decoder 36 may obtain the difference information from the bitstream and decode the depth image by using the difference information. Upon determining not to use the difference information for decoding, the depth image decoder 36 may decode the current prediction unit without obtaining the difference information from the bitstream.

A depth image prediction mode determiner 34 obtains information indicating whether the current prediction unit is split into partitions, from the bitstream, and determines whether to split the current prediction unit into at least one partition to decode the current prediction unit. Upon determining to split the current prediction unit into partitions to decode the current prediction unit, the depth image prediction mode determiner 34 obtains prediction information of the prediction unit from the bitstream, obtains a depth value of a partition corresponding to an original depth image and prediction information of the current prediction unit, and determines whether to perform decoding by using difference information indicating the difference from the depth value of the partition corresponding to the depth image. The prediction information of the current prediction unit may include a flag indicating whether to perform decoding by using the difference information included in the bitstream, and the depth image prediction mode determiner 34 may determine whether to perform decoding by using the difference information, based on the flag included in the bitstream.

The information indicating whether the current prediction unit is split into partitions may include a flag indicating whether the current prediction unit is in a predetermined intra prediction mode for splitting the current prediction unit into at least one partition to decode the current prediction unit, and the depth image prediction mode determiner 34 may determine whether to split the current prediction unit into at least one partition to decode the current prediction unit, based on the flag. In this case, the predetermined intra prediction mode may include a depth modeling mode (DMM). The DMM is a depth intra mode and is a technology of intra-prediction-coding a depth image based on a fact that the boundary between an object and a background of the depth image is clearly defined and a fact that variations in data value inside the object are small. That is, the depth intra mode may denote an intra prediction mode of a depth image. Based on a depth image decoding method according to an embodiment, in addition to prediction unit split structures and 35 intra prediction modes supported in conventional video encoding, a block may be split by using wedgelets which are straight lines or contours which are curved lines. In the depth intra mode, prediction is performed by defining data included in regions split by using the wedgelets or contours, based on an arbitrary average value.

The depth intra mode supports two modes depending on a wedgelet or contour setting scheme, e.g., mode 1 for coding wedgelets and mode 4 for coding contours. Particularly, unlike mode 1, mode 4 (i.e., DMM4) is a scheme for predicting curved lines. For example, in DMM4, an average luminance value of a block of a color image provided at a location corresponding to a block of the depth image to be currently coded may be calculated, the color image may be split into a plurality of partitions based on the calculated value to obtain split information, and the depth image may be split based on the split information.

When the depth image is intra-predicted in a depth intra mode such as DMM4, the depth image decoding apparatus 30 according to an embodiment may refer to the block of the color image corresponding to the block of the depth image. The depth intra mode may be a mode of performing prediction by using information about the depth image and information about the color image. The depth image decoding apparatus 30 may obtain information about the type of a slice including the block of the depth image (e.g., slice type), from the bitstream. The slice_type may be included in a slice segment header. Slice types of I-type, P-type, and B-type may be provided in a conventional video decoding method. On a block included in a slice having a slice type of I-type, intra prediction may be performed with reference to an encoded and then decoded block of the same frame. On a block corresponding to P-type or B-type, inter prediction may be performed by using motion information between a frame corresponding to a block to be currently decoded and a block of a frame corresponding to another POC. That is, if the slice_type related to the block to be decoded is I-type, an image related to the block to be currently decoded may not be referred and only inter prediction may be performed by using prediction information related to another block of the frame including the block to be currently decoded. However, the depth image decoding method according to an embodiment supports the depth image, and a color image and a depth image having the same POC as the color image may be included in an access unit. The depth image is also decoded. The depth image decoding apparatus 30 checks the slice_type of a block included in the depth image and performs intra prediction on a prediction unit of the depth image if the block corresponds to I-type.

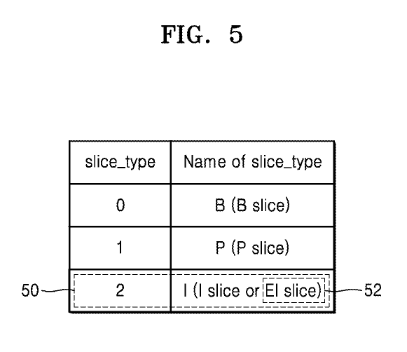

Furthermore, the depth image decoding method according to an embodiment supports the depth intra mode. Accordingly, a type of a slice capable of referring to a slice included in the color image of another frame included in the same access unit as the depth image to decode the depth image even when the slice type related to a block to be decoded is I-type may be provided. FIG. 5 is a table showing slice_types supported by the depth image decoding method according to an embodiment. Referring to FIG. 5, an I-type slice 50 corresponding to a slice_type of 2 may include an enhanced intra (EI) slice 52 as well as an I slice allowing only intra prediction based on a conventional video decoding method. The EI slice 52 allows not only intra prediction but also intra-view prediction on a prediction unit to be decoded. Intra-view prediction may be prediction based on a data element of a picture having the same view and included in the same access unit as a current picture. Based on intra-view prediction, a prediction unit of a depth image of a specific view may refer to a block of a color image of the specific view, which is included in the same access unit as the depth image. This prediction scheme may correspond to an intra contour mode (INTRA_CONTOUR) among depth intra modes. The depth intra mode may denote an intra prediction mode performed on a prediction unit of a depth image. The depth intra mode may be a particular intra prediction mode different from an intra prediction mode performed on a color image. The intra contour mode may be a prediction mode related to intra prediction of a depth image, and the depth image decoder 36 may split a block of the depth image into at least one partition by using information about a block of the color image provided at a location corresponding to the block of the depth image. Accordingly, the depth image prediction mode determiner 34 may determine whether depth intra prediction is performable on a prediction unit, with reference to the slice type included in a slice sequence header( ) of a slice related to the prediction unit.

The depth image decoding apparatus 30 according to an embodiment may further include a color image decoder (not shown) for reconstructing the color image corresponding to the depth image based on coding information of the color image. To allow a block of the depth image to be currently decoded to refer to a block of the color image included in the same access unit as the depth image, the color image should be decoded before the depth image. The depth image decoding apparatus 30 according to an embodiment may further include a color image decoder (not shown) for reconstructing the color image based on coding information of the color image obtained from the bitstream. Furthermore, the depth image decoder 36 according to an embodiment may receive the bitstream including coding information of the depth image, coding information of the color image corresponding to the depth image, and correlation information between the color image and the depth image. As such, the depth image decoding apparatus 30 may reconstruct the color image from the bitstream, and the depth image decoder 36 may decode the depth image corresponding to the color image by using the encoded and then reconstructed color image. Particularly, the depth image decoder 36 according to an embodiment decodes the depth image in consideration of the correlations between the depth image and the color image corresponding thereto. The depth image decoder 36 may split the block of the previously encoded and then reconstructed color image into partitions based on pixel values to determine the correlations, determine parameters for defining the correlations between the color image and the depth image per partition in consideration of correlations between neighboring pixels, and predict partitions of the block of the depth image corresponding to the split partitions of the block of the previously encoded and then reconstructed color image, by using the determined parameters.

The depth image decoder 36 according to an embodiment may split the largest coding unit of the depth image into at least one coding unit based on the split information of the depth image obtained from the bitstream. An intra prediction mode or an inter prediction mode may be determined per coding unit split as described above.

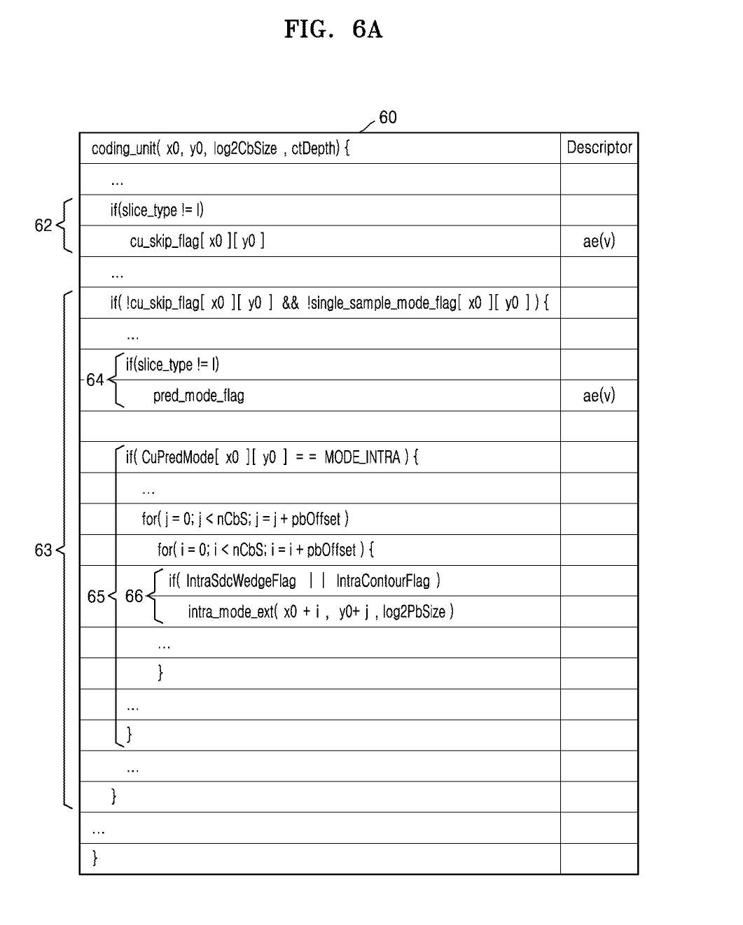

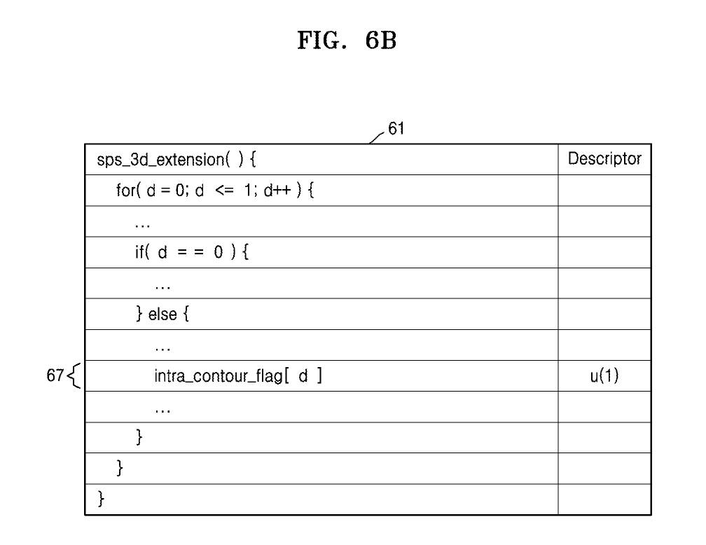

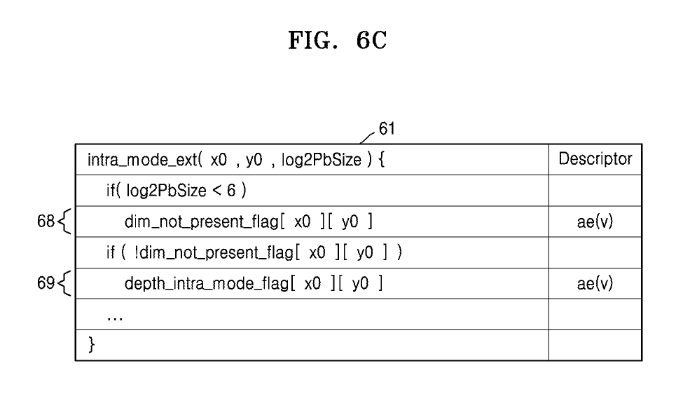

The depth image decoder 36 according to an embodiment may split the coding unit into at least one prediction unit for prediction decoding. The depth image prediction mode determiner 34 may determine whether to perform intra prediction on the determined coding unit. That is, if the prediction unit is split from the coding unit and it is determined to perform intra prediction on the coding unit, intra prediction may be performed on the prediction unit split from the coding unit. In this regard, FIG. 6A is a table showing syntax for performing decoding by determining a prediction mode to be performed on a prediction unit of a current coding unit, according to an embodiment. Referring to FIG. 6A, coding_unit( ) syntax 60 for the current coding unit may include conditional statements and iterative statements for determining an intra prediction mode of a prediction unit of the depth image. The depth image prediction mode determiner 34 may determine the prediction mode based on whether prediction mode information of the current coding unit, e.g., CuPredMode[x0] [y0], indicates MODE_INTRA. Herein, x0 and y0 may be information about top left coordinates of the current coding unit. If the slice_type of a slice related to a coding unit of the current depth image is not I-type, a conditional statement 62 is not satisfied and thus a cu_skip_flag[x0][y0] is not obtained from the bitstream. If the cu_skip_flag[x0][y0] is not obtained from the bitstream, the cu_skip_flag[x0][y0] corresponds to a value 0 and thus a conditional statement 63 is satisfied. In addition, if the slice_type of the slice related to the coding unit of the current depth image is not I-type, a conditional statement 64 is not satisfied and thus a pred_mode_flag is not obtained from the bitstream. In this case, since the CuPredMode[x0][y0] may be regarded as MODE_INTRA, a conditional statement 65 is satisfied and thus a conditional statement 66 may be executed.

A detailed description is now given of operation of the depth image decoding apparatus 30 with reference to FIG. 3B.

FIG. 3B is a flowchart of a depth image decoding method according to an embodiment.

In operation 301, the depth image decoding apparatus 30 may obtain a first flag including information about use of an intra contour mode related to intra prediction of a depth image, from a bitstream. According to an embodiment, the first flag obtained from the bitstream may include information usable to determine whether to perform the intra contour mode and may include an intra_contour_flag[d]. In the following description, for convenience of explanation, it is assumed that the first flag is the intra_contour_flag[d].

In operation 302, the depth image decoding apparatus 30 may determine whether to perform prediction in the intra contour mode on a prediction unit, based on the first flag. FIG. 6B is a table showing a sequence parameter set extension including an intra_contour_flag[d] 67, according to an embodiment. The sequence parameter set extension is a sequence parameter set further including additional information compared to a conventional sequence parameter set. The sequence parameter set extension according to an embodiment may be a sequence parameter set further including information used to decode the depth image, and may correspond to an sps_3d_extension( ) 61. In the following description, for convenience of explanation, it is assumed that the sequence parameter set extension is the sps_3d_extension( ) 61.

According to an embodiment, the information indicating whether to use the intra contour mode may be the intra_contour_flag[d] 67 included in the sps_3d_extension( ) 61, and d may denote a DepthFlag including information about whether a current view includes depth information. The depth image decoding apparatus 30 may determine whether the conditional statement 66 is satisfied, per prediction unit included in a current coding unit. The conditional statement 66 is satisfied if a depth intra mode is performable on the current coding unit. That is, the depth image prediction mode determiner 34 may determine whether the intra contour mode is performable on the prediction unit, based on whether the intra_contour_flag[d] 67 included in the sps_3d_extension( ) 61 related to the coding unit is obtained from the bitstream. According to an embodiment, the depth image prediction mode determiner 34 may obtain the intra_contour_flag[d] 67 including information about whether to perform DMM4 corresponding to an intra contour mode (INTRA_DEP_CONTOUR) among depth intra modes, from the bitstream. Referring to Equation 1, when the intra_contour_flag[d] 67 has a value 1, if another predetermined condition is satisfied (if nuh_layer_id>0 and textOfCurViewAvailFlag≠0), the value of the information about the intra contour mode may be 1. The information about the intra contour mode may be arbitrary information indicating the intra contour mode among depth intra modes to be performed on the prediction unit of the depth image, and may include an IntraContourFlag. In the following description, for convenience of explanation, it is assumed that the information about the intra contour mode is the IntraContourFlag.

IntraContourFlag=(nuh_layer_id>0) && intra_contour_flag[DepthFlag] && textOfCurViewAvailFlag [Equation 1]

Herein, the nuh_layer_id is a syntax element included in a network abstraction layer (NAL) unit header and may be a syntax element used in a decoding or encoding method including further extended information compared to a conventional video decoding or encoding method. Thus, unlike the conventional video encoding or decoding method, the nuh_layer_id may not be a value 0 in the depth image decoding method according to an embodiment. In addition, the textOfCurViewAvailFlag may include information about whether a color image of the current view is available. That is, according to an embodiment, if the nuh_layer_id is greater than a value 0, if the color image is available in the current view (or layer), and if the intra_contour_flag[DepthFlag] including information indicating that the intra contour mode is performed on the prediction unit of the view (or layer) corresponding to the nuh_layer_id, has a value 1, the IntraContourFlag including the information about the intra contour mode may have a value 1 and, in this case, the conditional statement 66 is satisfied. Accordingly, the depth image prediction mode determiner 34 may determine whether to perform prediction in the depth intra mode, based on the intra_contour_flag[d], and the depth intra mode may be the intra contour mode.

According to an embodiment, if the conditional statement 66 is satisfied, the depth image prediction mode determiner 34 may perform a function for performing depth intra prediction on prediction units included in the current coding unit. To perform depth intra prediction on the depth image, a function for performing an extended prediction mode different from a conventional intra prediction mode is necessary. The depth image prediction mode determiner 34 according to an embodiment may use an intra mode_ext(x0, y0, log 2PbSize) as a syntax element for performing depth intra prediction on the prediction units included in the current coding unit. The depth image prediction mode determiner 34 may use the intra_mode_ext(x0, y0, log 2PbSize) to obtain information about whether to perform depth intra prediction on the prediction unit of the depth image at a current location, and information about the type of depth intra prediction. FIG. 6C is a table showing syntax for describing an operation of obtaining a third flag and a second flag from the bitstream in the intra_mode_ext(x0, y0, log 2PbSize). Herein, the third flag may include information about whether to perform depth intra prediction on the prediction unit, and the second flag may include information about the type of the depth intra mode. That is, the third flag may be used to determine whether to perform depth intra prediction on the prediction unit of the depth image, and the second flag may be used to determine the type of the depth intra mode among intra prediction modes of the depth image. According to an embodiment, the second flag may be a depth_intra_mode_flag, and the third flag may be a dim_not_present_flag. In the following description, for convenience of explanation, it is assumed that the second flag is the depth_intra_mode_flag and the third flag is the dim_not_present_flag. Table 1 shows types of depth intra modes classified based on values of a DepthIntraMode.

TABLE 1

| DepthIntraMode | Associated name |
|---|---|
| −1 | INTRA_DEP_NONE |
| 0 | INTRA_DEP_WEDGE |
| 1 | INTRA_DEP_CONTOUR |

Herein, DepthIntraMode[x0][y0] is DepthIntraMode[x0][y0]=dim_not_present_flag[x0][y0]?−1: depth_intra_mode_flag[x0][y0]. That is, depth intra prediction is performed if the depth_intra_mode_flag[x0][y0] has a value 0 or 1 but is not performed if the depth_intra_mode_flag[x0][y0] has a value −1. The depth image prediction mode determiner 34 may split a block of the depth image by using straight lines (wedgelets) and determine an INTRA_DEP_WEDGE mode as a prediction mode thereof if the depth_intra_mode_flag[x0][y0] has a value 0, or may split the block of the depth image by using curved lines (contours) and determine an INTRA_DEP_CONTOUR mode as a prediction mode thereof if the depth_intra_mode_flag[x0][y0] has a value 1. That is, the depth image prediction mode determiner 34 according to an embodiment may determine whether to perform prediction on the prediction unit in the intra contour mode, by performing an intra_mode_ext (x0+i, y0+j, log 2PbSize) if the conditional statement 66 is satisfied when the intra_contour_flag[d] has a value 1, and determining whether the dim_not_present_flag[x0] [y0] obtained from the bitstream has a value 0 in the performed intra_mode_ext (x0+i, y0+j, log 2PbSize). If the dim_not_present_flag[x0] [y0] has a value 0, the depth image prediction mode determiner 34 may obtain the depth_intra_mode_flag[x0][y0] from the bitstream and determine whether the flag has a value corresponding to INTRA_DEP_CONTOUR. Upon determining that the depth_intra_mode_flag[x0][y0] has a value corresponding to INTRA_DEP_CONTOUR, the depth image prediction mode determiner 34 may determine to perform the intra contour mode on the prediction unit.

Upon determining to perform intra contour prediction on the prediction unit in operation 302, in operation 303, the depth image decoding apparatus 30 may perform intra contour prediction on the depth image. Even when the slice type related to the current prediction unit of the depth image in the intra contour mode is I-type, the depth image decoding apparatus 30 may perform prediction with reference to the color image included in the same access unit as the depth image.

In operation 304, the depth image decoding apparatus 30 may decode the depth image based on a result of performing intra contour prediction on the prediction unit in operation 303.

A description is now given of a depth image encoding apparatus 40 and a depth image encoding method according to other embodiments. The depth image encoding apparatus 40 and the depth image encoding method may inversely correspond to the above-described depth image decoding apparatus 30 and the operation thereof, and embodiments thereof may be easily understood by one of ordinary skill in the art.

The depth image decoding apparatus 30 and the depth image decoding method according to embodiments may perform decoding in a 4:0:0 format for configuring depth image information as luminance information, or in a 4:0:0 format for configuring disparity information as luminance information. Furthermore, the depth image decoding apparatus 30 and the depth image decoding method may use luminance information decoded in a 4:0:0 format, to implement a 3D image.

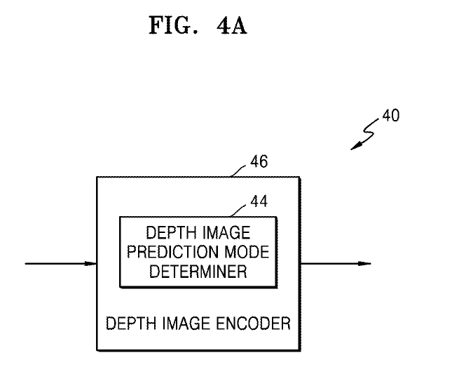

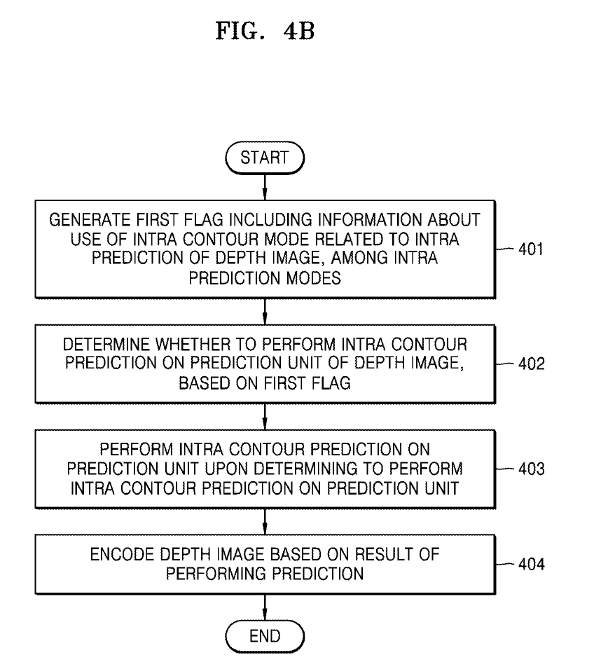

FIG. 4A is a block diagram of a depth image encoding apparatus 40. The depth image encoding apparatus 40 of FIG. 4A may correspond to the multi-view video encoding apparatus 12 of FIG. 1.

Referring to FIG. 4A, a depth image encoder 46 splits a largest coding unit of a depth image into at least one coding unit. The depth image encoder 46 splits the coding unit into at least one prediction unit for prediction encoding. The depth image encoder 46 encodes a current prediction unit by using difference information based on whether the current prediction unit is split into partitions and whether the difference information is used. In this case, the depth image encoder 46 intra-prediction-encodes the current prediction unit by using the difference information.

The depth image encoder 46 may obtain the difference information from a bitstream and encode the depth image by using the difference information. Upon determining not to use the difference information for encoding, the depth image encoder 46 may encode the current prediction unit without obtaining the difference information from the bitstream.

A depth image prediction mode determiner 44 obtains information indicating whether the current prediction unit is split into partitions, from the bitstream, and determines whether to split the current prediction unit into at least one partition to encode the current prediction unit. Upon determining to split the current prediction unit into partitions to encode the current prediction unit, the depth image prediction mode determiner 44 obtains prediction information of the prediction unit from the bitstream, obtains a depth value of a partition corresponding to an original depth image and prediction information of the current prediction unit, and determines whether to perform encoding by using difference information indicating the difference from the depth value of the partition corresponding to the depth image. The prediction information of the current prediction unit may include a flag indicating whether to perform encoding by using the difference information included in the bitstream, and the depth image prediction mode determiner 44 may determine whether to perform encoding by using the difference information, based on the flag included in the bitstream.

The information indicating whether the current prediction unit is split into partitions may include a flag indicating whether the current prediction unit is in a predetermined intra prediction mode for splitting the current prediction unit into at least one partition to encode the current prediction unit, and the depth image prediction mode determiner 44 may determine whether to split the current prediction unit into at least one partition to encode the current prediction unit, based on the flag. In this case, the predetermined intra prediction mode may include a depth modeling mode (DMM). The DMM is a depth intra mode and is a technology of intra-prediction-coding a depth image based on a fact that the boundary between an object and a background of the depth image is clearly defined and a fact that variations in data value inside the object are small. That is, the depth intra mode may denote an intra prediction mode of a depth image. Based on a depth image encoding method according to an embodiment, in addition to prediction unit split structures and 35 intra prediction modes supported in conventional video decoding, a block may be split by using wedgelets which are straight lines or contours which are curved lines. In the depth intra mode, prediction is performed by defining data included in regions split by using the wedgelets or contours, based on an arbitrary average value.

The depth intra mode supports two modes depending on a wedgelet or contour setting scheme, e.g., mode 1 for coding wedgelets and mode 4 for coding contours. Particularly, unlike mode 1, mode 4 (i.e., DMM4) is a scheme for predicting curved lines. For example, in DMM4, an average luminance value of a block of a color image provided at a location corresponding to a block of the depth image to be currently coded may be calculated, the color image may be split into a plurality of partitions based on the calculated value to obtain split information, and the depth image may be split based on the split information.

When the depth image is intra-predicted in a depth intra mode such as DMM4, the depth image encoding apparatus 40 according to an embodiment may refer to the block of the color image corresponding to the block of the depth image. The depth intra mode may be a mode of performing prediction by using information about the depth image and information about the color image. The depth image encoding apparatus 40 may generate a bitstream including information about the type of a slice including the block of the depth image (e.g., slice_type). The slice_type may be included in a slice segment header. Slice types of I-type, P-type, and B-type may be provided in a conventional video encoding method. On a block included in a slice having a slice type of I-type, encoding may be performed and intra prediction may be performed with reference to an encoded block of the same image. On a block corresponding to P-type or B-type, inter prediction may be performed by using motion information between an image corresponding to a block to be currently encoded and a block of an image corresponding to another POC. That is, if the slice_type related to the block to be encoded is I-type, an image related to the block to be currently encoded may not be referred and only inter prediction may be performed by using prediction information related to another block of the image including the block to be currently encoded. However, the depth image encoding method according to an embodiment supports the depth image, and a color image and a depth image having the same POC as the color image may be included in an access unit. The depth image is also encoded. The depth image encoding apparatus 40 checks the slice_type of a block included in the depth image and performs intra prediction on a prediction unit of the depth image if the block corresponds to I-type.

Furthermore, the depth image encoding method according to an embodiment supports the depth intra mode. Accordingly, a type of a slice capable of referring to a slice included in the color image of another frame included in the same access unit as the depth image to encode the depth image even when the slice type related to a block to be encoded is I-type may be provided. FIG. 5 is a table showing slice_types supported by the depth image decoding method according to an embodiment. Referring to FIG. 5, an I-type slice 50 corresponding to a slice_type of 2 may include an enhanced intra (EI) slice 52 as well as an I slice allowing only intra prediction based on a conventional video encoding method. The EI slice 52 allows not only intra prediction but also intra-view prediction on a prediction unit to be encoded. Intra-view prediction may be prediction based on a data element of a picture having the same view and included in the same access unit as a current picture. Based on intra-view prediction, a prediction unit of a depth image of a specific view may refer to a block of a color image of the specific view, which is included in the same access unit as the depth image. This prediction scheme may correspond to an intra contour mode (INTRA_CONTOUR) among depth intra modes. The depth intra mode may denote an intra prediction mode performed on a prediction unit of a depth image. The depth intra mode may be a particular intra prediction mode different from an intra prediction mode performed on a color image. The intra contour mode may be a prediction mode related to intra prediction of a depth image, and the depth image encoder 46 may split a block of the depth image into at least one partition by using information about a block of the color image provided at a location corresponding to the block of the depth image. Accordingly, the depth image prediction mode determiner 44 may determine whether depth intra prediction is performable on a prediction unit, with reference to the slice type included in a slice sequence header( ) of a slice related to the prediction unit.

The depth image encoding apparatus 40 according to an embodiment may further include a color image decoder (not shown) for decoding the color image corresponding to the depth image based on coding information of the color image. The depth image encoder 46 may generate a bitstream including coding information of the depth image, coding information of the color image corresponding to the depth image, and correlation information between the color image and the depth image. As such, the depth image encoding apparatus 40 may encode the color image, and the depth image encoder 46 may encode the depth image corresponding to the color image by using the encoded and then reconstructed color image. Particularly, the depth image encoder 46 according to an embodiment encodes the depth image in consideration of the correlations between the depth image and the color image corresponding thereto. The depth image encoder 46 may split the block of the previously encoded and then reconstructed color image into partitions based on pixel values to determine the correlations, determine parameters for defining the correlations between the color image and the depth image per partition in consideration of correlations between neighboring pixels, and predict at least one partition of the block of the depth image corresponding to the split partitions of the block of the previously encoded and then reconstructed color image, by using the determined parameters.

The depth image encoder 46 according to an embodiment may split the largest coding unit of the depth image into at least one coding unit. An intra prediction mode or an inter prediction mode may be determined per coding unit split as described above.

The depth image encoder 46 according to an embodiment may split the coding unit into at least one prediction unit for prediction encoding. The depth image prediction mode determiner 44 may determine whether to perform intra prediction on the determined coding unit. That is, if the prediction unit is split from the coding unit and it is determined to perform intra prediction on the coding unit, intra prediction may be performed on the prediction unit split from the coding unit. In this regard, FIG. 6A is a table showing syntax for performing encoding by determining a prediction mode to be performed on a prediction unit of a current coding unit, according to an embodiment. Referring to FIG. 6A, coding_unit( ) syntax 60 for the current coding unit may include conditional statements and iterative statements for determining an intra prediction mode of a prediction unit of the depth image. The depth image prediction mode determiner 44 may determine the prediction mode based on whether prediction mode information of the current coding unit, e.g., CuPredMode[x0] [y0], indicates MODE_INTRA. Herein, x0 and y0 may be information about top left coordinates of the current coding unit. If the slice_type of a slice related to a coding unit of the current depth image is not I-type, a conditional statement 62 is not satisfied and thus a cu_skip_flag[x0][y0] is not generated. If the cu_skip_flag[x0][y0] is not generated, the cu_skip_flag[x0] [y0] corresponds to a value 0 and thus a conditional statement 63 is satisfied. In addition, if the slice_type of the slice related to the coding unit of the current depth image is not I-type, a conditional statement 64 is not satisfied and thus a pred_mode_flag is not generated. In this case, since the CuPredMode[x0] [y0] may be regarded as MODE_INTRA, a conditional statement 65 is satisfied and thus a conditional statement 66 may be executed.

A detailed description is now given of operation of the depth image encoding apparatus 40 with reference to FIG. 4B.

FIG. 4B is a flowchart of a depth image encoding method according to an embodiment.

In operation 401, the depth image encoding apparatus 40 may generate a first flag including information about use of an intra contour mode related to intra prediction of a depth image. According to an embodiment, the first flag may include information usable to determine whether to perform the intra contour mode and may include an intra_contour_flag[d]. In the following description, for convenience of explanation, it is assumed that the first flag is the intra_contour_flag[d].

In operation 402, the depth image encoding apparatus 40 may determine whether to perform prediction in the intra contour mode on a prediction unit, based on the first flag. FIG. 6B is a table showing a sequence parameter set extension including an intra_contour_flag[d] 67, according to an embodiment. The sequence parameter set extension is a sequence parameter set further including additional information compared to a conventional sequence parameter set. The sequence parameter set extension according to an embodiment may be a sequence parameter set further including information used to encode the depth image, and may correspond to an sps_3d_extension( ) 61. In the following description, for convenience of explanation, it is assumed that the sequence parameter set extension is the sps_3d_extension( ) 61.

According to an embodiment, the information indicating whether to use the intra contour mode may be the intra_contour_flag[d] 67 included in the sps_3d_extension( ) 61, and d may denote a DepthFlag including information about whether a current view includes depth information. The depth image encoding apparatus 40 may determine whether the conditional statement 66 is satisfied, per prediction unit included in a current coding unit. The conditional statement 66 is satisfied if a depth intra mode is performable on the current coding unit. That is, the depth image prediction mode determiner 44 may determine whether the intra contour mode is performable on the prediction unit, based on whether the intra_contour_flag[d] 67 included in the sps_3d_extension( ) 61 related to the coding unit is generated. According to an embodiment, the depth image prediction mode determiner 44 may generate the intra_contour_flag[d] 67 including information about whether to perform DMM4 corresponding to an intra contour mode (INTRA_DEP_CONTOUR) among depth intra modes. In the depth image encoding method, information about whether to perform intra contour prediction may also be generated by using Equation 1. Referring to Equation 1, when the intra_contour_flag[d] 67 has a value 1, if another predetermined condition is satisfied (if nuh_layer_id>0 and textOfCurViewAvailFlag≠0), the value of the information about the intra contour mode may be 1. The information about the intra contour mode may be arbitrary information indicating the intra contour mode among depth intra modes to be performed on the prediction unit of the depth image, and may include an IntraContourFlag. In the following description, for convenience of explanation, it is assumed that the information about the intra contour mode is the IntraContourFlag. Herein, the nuh_layer_id is a syntax element included in a network abstraction layer (NAL) unit header and may be a syntax element used in a encoding or encoding method including further extended information compared to a conventional video encoding or encoding method. Thus, unlike the conventional video encoding or encoding method, the nuh_layer_id may not be a value 0 in the depth image encoding method according to an embodiment. In addition, the textOfCurViewAvailFlag may be information about whether a color image of the current view is available. That is, when the depth image encoding apparatus 40 encodes the depth image, if the nuh_layer_id of the depth image in the current view (or layer) is greater than a value 0, if the color image is available in the view, and if the intra_contour_flag[DepthFlag] including information indicating that the intra contour mode is performed on the prediction unit of the view corresponding to the nuh_layer_id, has a value 1, the IntraContourFlag including the information about the intra contour mode may have a value 1 and, in this case, the conditional statement 66 is satisfied. Accordingly, the depth image prediction mode determiner 44 may determine whether to perform prediction in the depth intra mode, based on the intra_contour_flag[d], and the depth intra mode may be the intra contour mode.

According to an embodiment, if the conditional statement 66 is satisfied, the depth image prediction mode determiner 44 may perform a function for performing depth intra prediction on prediction units included in the current coding unit. To perform depth intra prediction on the depth image, a function for performing an extended prediction mode different from a conventional intra prediction mode is necessary. The depth image prediction mode determiner 44 according to an embodiment may use an intra_mode_ext(x0, y0, log 2PbSize) as a syntax element for performing depth intra prediction on the prediction units included in the current coding unit. The depth image prediction mode determiner 44 may use the intra_mode_ext(x0, y0, log 2PbSize) to generate information about whether to perform depth intra prediction on the prediction unit of the depth image at a current location, and information about the type of depth intra prediction. FIG. 6C is a table showing syntax for describing an operation of obtaining a third flag and a second flag from the bitstream in the intra_mode_ext(x0, y0, log 2PbSize). The third flag may include information about whether to perform depth intra prediction on the current prediction unit, and the second flag may include information about the type of the depth intra mode. That is, the third flag may be used to determine whether to perform depth intra prediction on the prediction unit of the depth image, and the second flag may be used to determine the type of the depth intra mode among intra prediction modes of the depth image. According to an embodiment, the second flag may be a depth_intra_mode_flag, and the third flag may be a dim_not_present_flag. In the following description, for convenience of explanation, it is assumed that the second flag is the depth_intra_mode_flag and the third flag is the dim_not_present_flag. Referring to Table 1, types of depth intra modes may be classified based on values of a DepthIntraMode. Herein, DepthIntraMode[x0][y0] is DepthIntraMode[x0][y0]=dim_not_present_flag[x0][y0]?−1: depth_intra_mode_flag[x0][y0]. That is, depth intra prediction is performed if the depth_intra_mode_flag[x0][y0] has a value 0 or 1 but is not performed if the depth_intra_mode_flag[x0][y0] has a value −1. The depth image prediction mode determiner 44 may split a block of the depth image by using straight lines (wedgelets) and determine an INTRA_DEP_WEDGE mode as a prediction mode thereof if the depth_intra_mode_flag[x0][y0] has a value 0, or may split the block of the depth image by using curved lines (contours) and determine an INTRA_DEP_CONTOUR mode as a prediction mode thereof if the depth_intra_mode_flag[x0][y0] has a value 1. That is, the depth image prediction mode determiner 44 according to an embodiment determines whether to perform prediction on the prediction unit in the intra contour mode, by performing an intra_mode_ext (x0+i, y0+j, log 2PbSize) if the conditional statement 66 is satisfied when the intra_contour_flag[d] has a value 1, and determining whether the dim_not_present_flag[x0] [y0] obtained from the bitstream has a value 0 in the performed intra_mode_ext (x0+i, y0+j, log 2PbSize). If the dim_not_present_flag[x0] [y0] has a value 0, the depth image prediction mode determiner 44 may generate the depth_intra_mode_flag[x0][y0] and determine whether the flag has a value corresponding to INTRA_DEP_CONTOUR. Upon determining that the depth_intra_mode_flag[x0][y0] has a value corresponding to INTRA_DEP_CONTOUR, the depth image prediction mode determiner 44 may determine to perform the intra contour mode on the prediction unit.

Upon determining to perform intra contour prediction on the prediction unit in operation 402, in operation 403, the depth image encoding apparatus 40 may perform intra contour prediction on the depth image. Even when the slice type related to the prediction unit of the depth image in the intra contour mode is I-type, the depth image encoding apparatus 40 may perform prediction with reference to the color image included in the same access unit as the depth image.

In operation 404, the depth image encoding apparatus 40 may encode the depth image based on a result of performing intra contour prediction on the prediction unit in operation 403.

The depth image encoding apparatus 40 and the depth image encoding method according to embodiments may perform encoding in a 4:0:0 format for configuring depth image information as luminance information, or in a 4:0:0 format for configuring disparity information as luminance information. Furthermore, the depth image encoding apparatus 40 and the depth image encoding method may use luminance information encoded in a 4:0:0 format, to implement a 3D image.

FIG. 7 is a block diagram of a video encoding apparatus based on coding units according to tree structure 100, according to an embodiment.

The video encoding apparatus involving video prediction based on coding units of tree structure 100 according to the embodiment includes a largest coding unit splitter 110, a coding unit determiner 120 and an output unit 130. Hereinafter, for convenience of description, the video encoding apparatus involving video prediction based on coding units of tree structure 100 according to the embodiment will be abbreviated to the ‘video encoding apparatus 100’.

The coding unit determiner 120 may split a current picture based on a largest coding unit that is a coding unit having a maximum size for a current picture of an image. If the current picture is larger than the largest coding unit, image data of the current picture may be split into the at least one largest coding unit. The largest coding unit according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit is an uppermost depth and a depth of the smallest coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to an embodiment is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be previously set.

The coding unit determiner 120 encodes at least one split region obtained by splitting a region of the largest coding unit according to depths, and determines a depth to output a finally encoded image data according to the at least one split region. In other words, the coding unit determiner 120 determines a final depth by encoding the image data in the deeper coding units according to depths, according to the largest coding unit of the current picture, and selecting a depth having the least encoding error. The determined final depth and the encoded image data according to the determined coded depth are output to the output unit 130.

The image data in the largest coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one final depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, at least one final depth may be determined in one largest coding unit, and the image data of the largest coding unit may be divided according to coding units of the at least one final depth.

Accordingly, the coding unit determiner 120 according to an embodiment may determine coding units having a tree structure included in the largest coding unit. The ‘coding units having a tree structure’ according to an embodiment include coding units corresponding to a depth determined to be the final depth, from among all deeper coding units included in the largest coding unit. A coding unit of a final depth may be hierarchically determined according to depths in the same region of the largest coding unit, and may be independently determined in different regions. Equally, a final depth in a current region may be independently determined from a final depth in another region.

A maximum depth according to an embodiment is an index related to the number of splitting times from a largest coding unit to a smallest coding unit. A first maximum depth according to an embodiment may denote the total number of splitting times from the largest coding unit to the smallest coding unit. A second maximum depth according to an embodiment may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. In this regard, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. For convenience of description, the prediction encoding and the transformation will now be described based on a coding unit of a current depth, in a largest coding unit.

The video encoding apparatus 100 according to an embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the largest coding unit, the prediction encoding may be performed based on a coding unit corresponding to a final depth according to an embodiment, i.e., based on a coding unit that is no longer split to coding units corresponding to a lower depth. A partition obtained by splitting the coding unit may include the coding unit and a data unit obtained by splitting at least one of a height and a width of the coding unit. A partition may include a data unit where a coding unit is split, and a data unit having the same size as the coding unit. The partition that becomes a base unit for prediction will now be referred to as a ‘prediction unit’.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode according to an embodiment may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, or partitions having arbitrary shapes.

A prediction mode of the prediction unit may be at least one of an intra mode, an inter mode, and a skip mode. For example, the intra mode and the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 according to an embodiment may perform not only the transformation on the image data in a coding unit based not only on the coding unit for encoding the image data, but also may perform the transformation on the image data based on a data unit that is different from the coding unit. In order to perform the transformation in the coding unit, the transformation may be performed based on a transformation unit having a size less than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to an embodiment. Thus, residual data in the coding unit may be split according to the transformation unit having the tree structure according to transformation depths.

A transformation depth indicating the number of splitting times to reach the transformation unit by splitting the height and width of the coding unit may also be set in the transformation unit according to an embodiment. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, the transformation unit having the tree structure may be set according to the transformation depths.

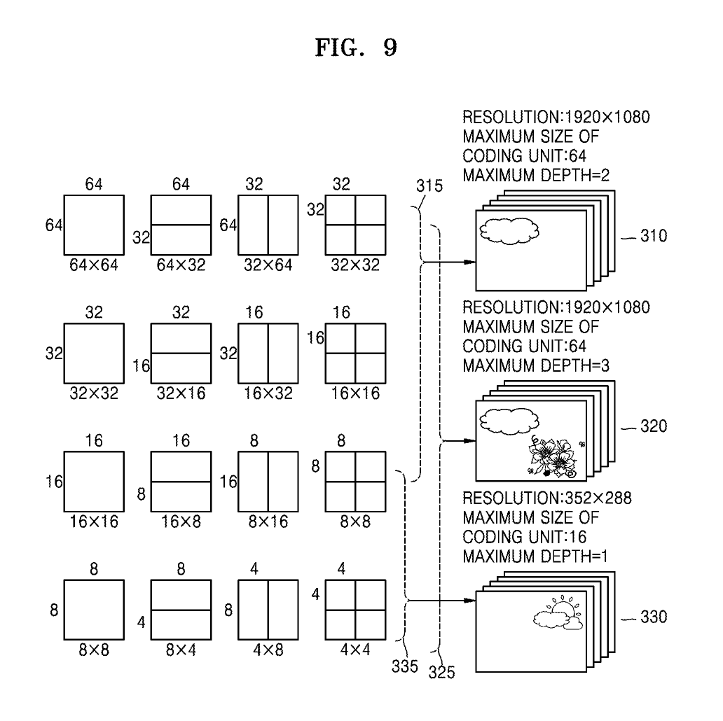

Split information according to depths requires not only information about a depth but also requires information related to prediction encoding and transformation. Accordingly, the coding unit determiner 120 not only determines a depth having a least encoding error, but also determines a partition mode of splitting a prediction unit into a partition, a prediction mode according to prediction units, and a size of a transformation unit for transformation. Coding units according to a tree structure in a largest coding unit and methods of determining a prediction unit/partition, and a transformation unit, according to an embodiment, will be described in detail below with reference to FIGS. 9 through 19.

The coding unit determiner 120 may measure an encoding error of deeper coding units according to depths by using Rate-Distortion Optimization based on Lagrangian multipliers.

The output unit 130 outputs the image data of the largest coding unit, which is encoded based on the at least one depth determined by the coding unit determiner 120, and split information according to the depth, in bitstreams.

The encoded image data may be obtained by encoding residual data of an image.

The split information according to depth may include information about the depth, about the partition mode in the prediction unit, about the prediction mode, and about split of the transformation unit.

The information about the final depth may be defined by using split information according to depths, which indicates whether encoding is performed on coding units of a lower depth instead of a current depth. If the current depth of the current coding unit is a final depth, the current coding unit is encoded, and thus the split information may be defined not to split the current coding unit to a lower depth. Alternatively, if the current depth of the current coding unit is not the final depth, the encoding is performed on the coding unit of the lower depth, and thus the split information may be defined to split the current coding unit to obtain the coding units of the lower depth.

If the current depth is not the final depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and split information is determined for a coding unit of a depth, at least one piece of split information may be determined for one largest coding unit. Also, a depth of the image data of the largest coding unit may be different according to locations since the image data is hierarchically split according to depths, and thus a depth and split information may be set for the image data.

Accordingly, the output unit 130 according to an embodiment may assign a corresponding depth and encoding information about an encoding mode to at least one of the coding unit, the prediction unit, and a minimum unit included in the largest coding unit.

The minimum unit according to an embodiment is a square data unit obtained by splitting the smallest coding unit constituting the lowermost depth by 4. Alternatively, the minimum unit according to an embodiment may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The output unit 130 may encode and output reference information related to prediction, prediction information, and slice type information.

In the video encoding apparatus 100 according to the simplest embodiment, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to an embodiment, image compression efficiency may be increased since a coding unit is adjusted while considering characteristics of an image while increasing a maximum size of a coding unit while considering a size of the image.

The depth image encoding apparatus 40 described above with reference to FIG. 4A may include as many video encoding apparatuses 100 as the number of layers, in order to encode single-layer images according to layers of a multi-layer video. For example, the first layer encoder 12 may include one video encoding apparatus 100, and the depth image encoder 14 may include as many video encoding apparatuses 100 as the number of second layers.

When the video encoding apparatus 100 encodes first layer images, the coding unit determiner 120 may determine, for each largest coding unit, a prediction unit for inter-prediction according to coding units having a tree structure, and may perform inter-prediction according to prediction units.

Even when the video encoding apparatus 100 encodes second layer images, the coding unit determiner 120 may determine, for each largest coding unit, coding units and prediction units having a tree structure, and may perform inter-prediction according to prediction units.

The video encoding apparatus 100 may encode a luminance difference to compensate for a luminance difference between a first layer image and a second layer image. However, whether to perform luminance may be determined according to an encoding mode of a coding unit. For example, luminance compensation may be performed only on a prediction unit having a size of 2N×2N.

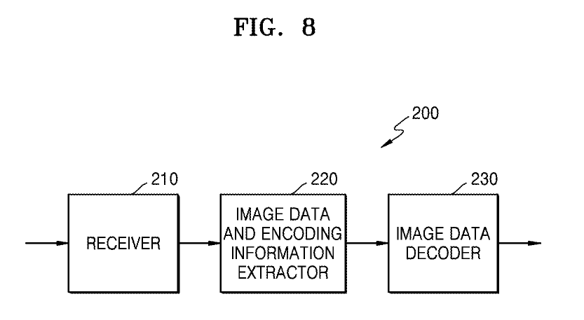

FIG. 8 is a block diagram of a video decoding apparatus based on coding units according to tree structure 200, according to various embodiments.

The video decoding apparatus involving video prediction based on coding units according to tree structure 200 according to an embodiment includes a receiver 210, an image data and encoding information extractor 220, and an image data decoder 230. For convenience of description, the video decoding apparatus involving video prediction based on coding units according to tree structure 200 according to an embodiment will be abbreviated to the ‘video decoding apparatus 200’.

Definitions of various terms, such as a coding unit, a depth, a prediction unit, a transformation unit, and various split information, for decoding operations of the video decoding apparatus 200 according to an embodiment are identical to those described with reference to FIG. 7 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and split information for the coding units having a tree structure according to each largest coding unit, from the parsed bitstream. The extracted final depth and split information are output to the image data decoder 230. That is, the image data in a bitstream is split into the largest coding unit so that the image data decoder 230 decodes the image data for each largest coding unit.

A depth and split information according to the largest coding unit may be set for at least one piece of depth information, and split information may include information about a partition mode of a corresponding coding unit, about a prediction mode, and about split of a transformation unit. Also, split information according to depths may be extracted as the information about a depth.

The depth and the split information according to each largest coding unit extracted by the image data and encoding information extractor 220 is a depth and split information determined to generate a least encoding error when an encoder, such as the video encoding apparatus 100 according to an embodiment, repeatedly performs encoding for each deeper coding unit according to depths according to each largest coding unit. Accordingly, the video decoding apparatus 200 may reconstruct an image by decoding the image data according to a coded depth and an encoding mode that generates the least encoding error.

Since encoding information according to an embodiment about a depth and an encoding mode may be assigned to a predetermined data unit from among a corresponding coding unit, a prediction unit, and a minimum unit, the image data and encoding information extractor 220 may extract the depth and the split information according to the predetermined data units. If the depth and the split information of a corresponding largest coding unit is recorded according to predetermined data units, the predetermined data units to which the same depth and the same split information is assigned may be inferred to be the data units included in the same largest coding unit.

The image data decoder 230 may reconstruct the current picture by decoding the image data in each largest coding unit based on the depth and the split information according to the largest coding units. That is, the image data decoder 230 may decode the encoded image data based on the extracted information about the partition mode, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Via the inverse transformation, a pixel value of a spatial region of the coding unit may be reconstructed.

The image data decoder 230 may determine a depth of a current largest coding unit by using split information according to depths. If the split information indicates that image data is no longer split in the current depth, the current depth is a depth. Accordingly, the image data decoder 230 may decode encoded data in the current largest coding unit by using the information about the partition mode of the prediction unit, the prediction mode, and the size of the transformation unit.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The depth image decoding apparatus 30 described above with reference to FIG. 3 may include video decoding apparatuses 200 as much as the number of viewpoints, so as to reconstruct first layer images and second layer images by decoding a received first layer image stream and a received second layer image stream.

When the first layer image stream is received, the image data decoder 230 of the video decoding apparatus 200 may split samples of first layer images extracted from the first layer image stream by the image data and encoding information extractor 220 into coding units having a tree structure. The image data decoder 230 may reconstruct the first layer images by performing motion compensation according to prediction units for inter prediction, on the coding units having the tree structure obtained by splitting the samples of the first layer images.

When the second layer image stream is received, the image data decoder 230 of the video decoding apparatus 200 may split samples of second layer images extracted from the second layer image stream by the image data and encoding information extractor 220 into coding units having a tree structure. The image data decoder 230 may reconstruct the second layer images by performing motion compensation according to prediction units for inter prediction, on the coding units obtained by splitting the samples of the second layer images.

The extractor 220 may obtain information related to a luminance error from a bitstream so as to compensate for a luminance difference between a first layer image and a second layer image. However, whether to perform luminance may be determined according to an encoding mode of a coding unit. For example, luminance compensation may be performed only on a prediction unit having a size of 2N×2N.

Thus, the video decoding apparatus 200 may obtain information about at least one coding unit that generates the least encoding error when encoding is recursively performed for each largest coding unit, and may use the information to decode the current picture. That is, the coding units having the tree structure determined to be the optimum coding units in each largest coding unit may be decoded.

Accordingly, even if an image has high resolution or has an excessively large data amount, the image may be efficiently decoded and reconstructed by using a size of a coding unit and an encoding mode, which are adaptively determined according to characteristics of the image, by using optimum split information received from an encoder.

FIG. 9 is a diagram for describing a concept of coding units according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

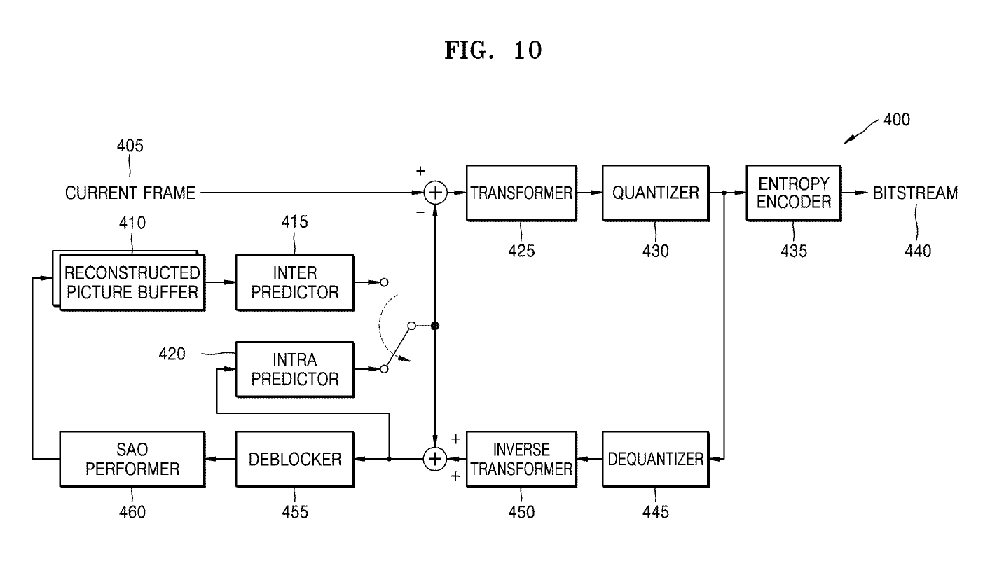

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 10 denotes a total number of splits from a largest coding unit to a smallest coding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a largest coding unit having a long axis size of 64, and coding units having long axis sizes of 32 and 16 since depths are deepened to two layers by splitting the largest coding unit twice. Since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, detailed information may be precisely expressed.

FIG. 10 is a block diagram of an image encoder 400 based on coding units, according to various embodiments.

The image encoder 400 according to an embodiment performs operations of the coding unit determiner 120 of the video encoding apparatus 100 to encode image data. That is, an intra predictor 420 performs intra prediction on coding units in an intra mode, from among a current frame 405, per prediction unit, and an inter predictor 415 performs inter prediction on coding units in an inter mode by using the current image 405 and a reference image obtained by a reconstructed picture buffer 410, per prediction unit. The current picture 405 may be split into largest coding units, and then the largest coding units may be sequentially encoded. Here, the encoding may be performed on coding units split in a tree structure from the largest coding unit.

Residue data is generated by subtracting prediction data of a coding unit of each mode output from the intra predictor 420 or the inter predictor 415 from data of the current image 405 to be encoded, and the residue data is output as a quantized transformation coefficient through a transformer 425 and a quantizer 430 per transformation unit. The quantized transformation coefficient is reconstructed to residual data in a spatial domain through an inverse quantizer 445 and an inverse transformer 450. The residue data in the spatial domain is added to the prediction data of the coding unit of each mode output from the intra predictor 420 or the inter predictor 415 to be reconstructed as data in a spatial domain of the coding unit of the current image 405. The data in the spatial domain passes through a deblocker 455 and a sample adaptive offset (SAO) performer 460 and thus a reconstructed image is generated. The reconstructed image is stored in the reconstructed picture buffer 410. Reconstructed images stored in the reconstructed picture buffer 410 may be used as a reference image for inter prediction of another image. The quantized transformation coefficient obtained through the transformer 425 and the quantizer 430 may be output as a bitstream 440 through an entropy encoder 435.

In order for the image encoder 400 according to an embodiment to be applied in the video encoding apparatus 100, components of the image encoder 400, i.e., the inter predictor 415, the intra predictor 420, the transformer 425, the quantizer 430, the entropy encoder 435, the inverse quantizer 445, the inverse transformer 450, the deblocking unit 455, and the SAO performer 460 perform operations based on each coding unit among coding units having a tree structure per largest coding unit.

In particular, the intra predictor 420 and the inter predictor 415 may determine partitions and a prediction mode of each coding unit from among the coding units having a tree structure while considering the maximum size and the maximum depth of a current largest coding unit, and the transformer 425 may determine whether to split a transformation unit according to a quad-tree in each coding unit from among the coding units having the tree structure.

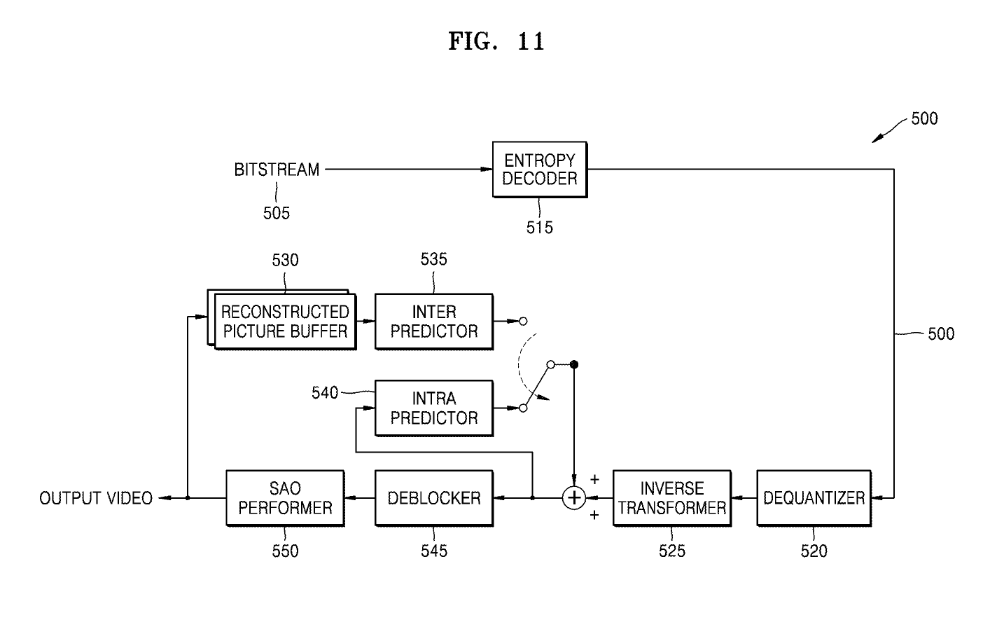

FIG. 11 is a block diagram of an image decoder 500 based on coding units according to various embodiments.

An entropy decoder 515 parses encoded image data that is to be decoded and encoding information required for decoding from a bitstream 505. The encoded image data is a quantized transformation coefficient, and an inverse quantizer 520 and an inverse transformer 525 reconstructs residual data from the quantized transformation coefficient.

An intra predictor 540 performs intra prediction on a coding unit in an intra mode according to prediction units. An inter predictor performs inter prediction on a coding unit in an inter mode from a current image according to prediction units, by using a reference image obtained by a reconstructed picture buffer 530.

Data in a spatial domain of coding units of the current image is reconstructed by adding the residual data and the prediction data of a coding unit of each mode through the intra predictor 540 or the inter predictor 535, and the data in the spatial domain may be output as a reconstructed image through a deblocking unit 545 and an SAO performer 550. Also, reconstructed images that are stored in the reconstructed picture buffer 530 may be output as reference images.

In order to decode the image data in the image data decoder 230 of the video decoding apparatus 200, operations after the entropy decoder 515 of the image decoder 500 according to various embodiments may be performed.

In order for the image decoder 500 to be applied in the video decoding apparatus 200 according to an embodiment, components of the image decoder 500, i.e., the entropy decoder 515, the inverse quantizer 520, the inverse transformer 525, the intra predictor 540, the inter predictor 535, the deblocking unit 545, and the SAO performer 550 may perform operations based on coding units having a tree structure for each largest coding unit.

In particular, the intra prediction 540 and the inter predictor 535 determine a partition mode and a prediction mode according to each of coding units having a tree structure, and the inverse transformer 525 may determine whether to split a transformation unit according to a quad-tree structure per coding unit.

An encoding operation of FIG. 10 and a decoding operation of FIG. 11 are respectively a video stream encoding operation and a video stream decoding operation in a single layer. Accordingly, when the encoder 12 of FIG. 3A encodes a video stream of at least two layers, the video encoding apparatus 10 of FIG. 4A may include as many image encoder 400 as the number of layers. Similarly, when the decoder 24 of FIG. 2A decodes a video stream of at least two layers, the video decoding apparatus 20 of FIG. 2A may include as many image decoders 500 as the number of layers.

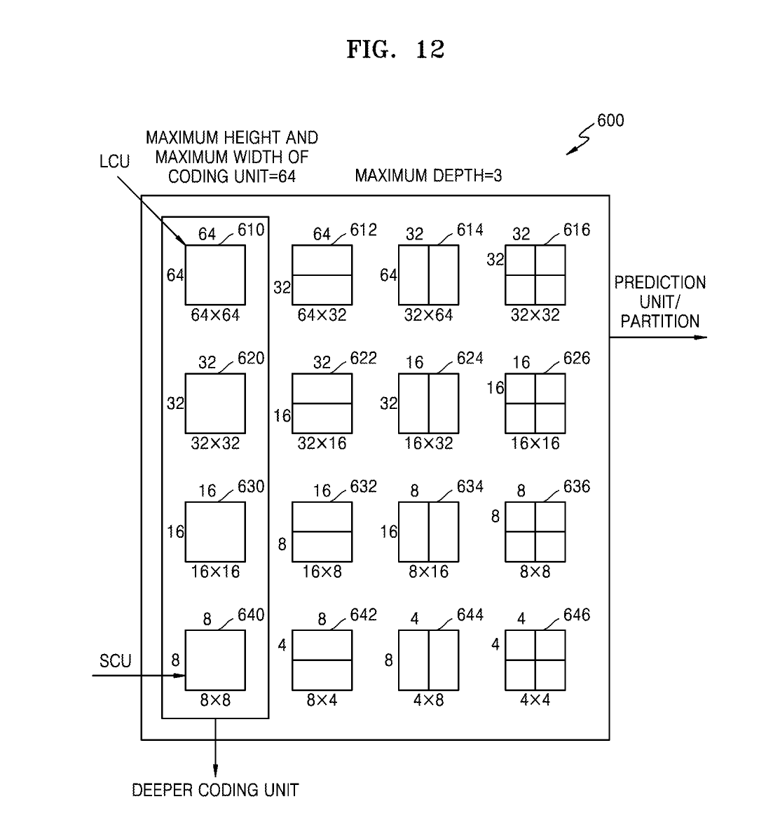

FIG. 12 is a diagram illustrating coding units according to depths and partitions, according to various embodiments.

The video encoding apparatus 100 according to an embodiment and the video decoding apparatus 200 according to an embodiment use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units according to an embodiment, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure 600 of coding units according to various embodiments, a height and a width of the deeper coding unit are each split. Also, a prediction unit and partitions, which are bases for prediction encoding of each deeper coding unit, are shown along a horizontal axis of the hierarchical structure 600.

That is, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is a smallest coding unit.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the coding unit 610 having a size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620 having a size of 32×32, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630 having a size of 16×16, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640 having a size of 8×8, i.e. a partition 640 having a size of 8×8 included in the coding unit 640, partitions 642 having a size of 8×4, partitions 644 having a size of 4×8, and partitions 646 having a size of 4×4.

In order to determine the depth of the largest coding unit 610, the coding unit determiner 120 of the video encoding apparatus 100 according to an embodiment performs encoding for coding units corresponding to each depth included in the maximum coding unit 610.

The number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the least encoding error may be searched for by comparing the least encoding errors according to depths, by performing encoding for each depth as the depth deepens along the vertical axis of the hierarchical structure 600. A depth and a partition having the least encoding error in the largest coding unit 610 may be selected as the depth and a partition mode of the largest coding unit 610.

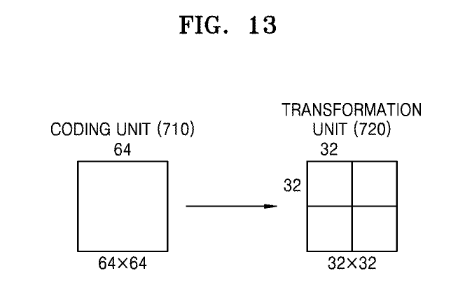

FIG. 13 is a diagram for describing a relationship between a coding unit and transformation units, according to various embodiments.

The video encoding apparatus 100 according to an embodiment or the video decoding apparatus 200 according to an embodiment encodes or decodes an image according to coding units having sizes less than or equal to a largest coding unit for each largest coding unit. Sizes of transformation units for transformation during encoding may be selected based on data units that are not larger than a corresponding coding unit.

For example, in the video encoding apparatus 100 according to an embodiment or the video decoding apparatus 200 according to an embodiment, if a size of a coding unit 710 is 64×64, transformation may be performed by using a transformation unit 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

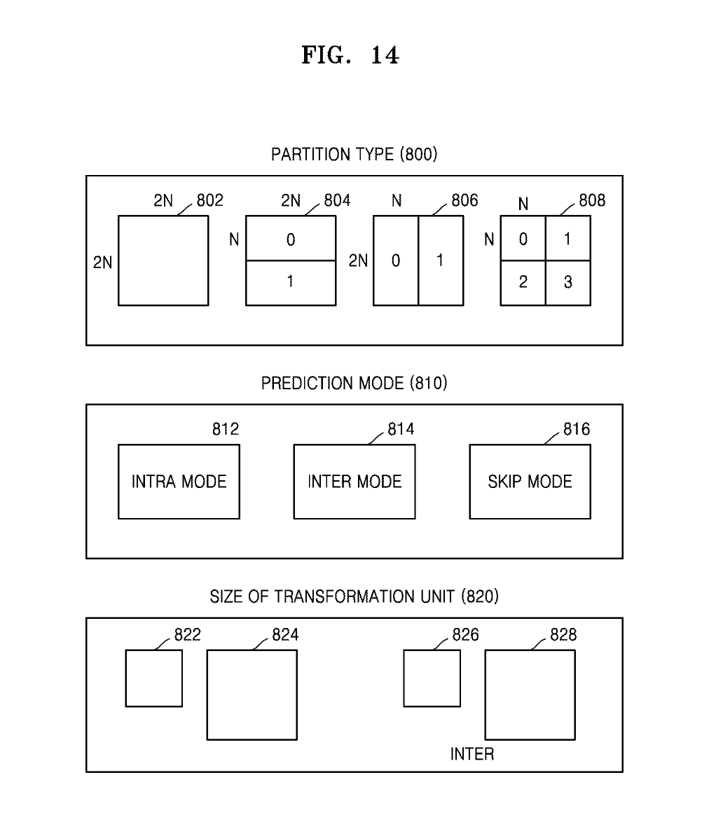

FIG. 14 illustrates a plurality of pieces of encoding information according to depths, according to various embodiments.

The output unit 130 of the video encoding apparatus 100 according to an embodiment may encode and transmit information 800 about a partition mode, information 810 about a prediction mode, and information 820 about a size of a transformation unit for each coding unit corresponding to a depth, as split information.

The information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 according to an embodiment may extract and use the information 800, 810, and 820 for decoding, according to each deeper coding unit.

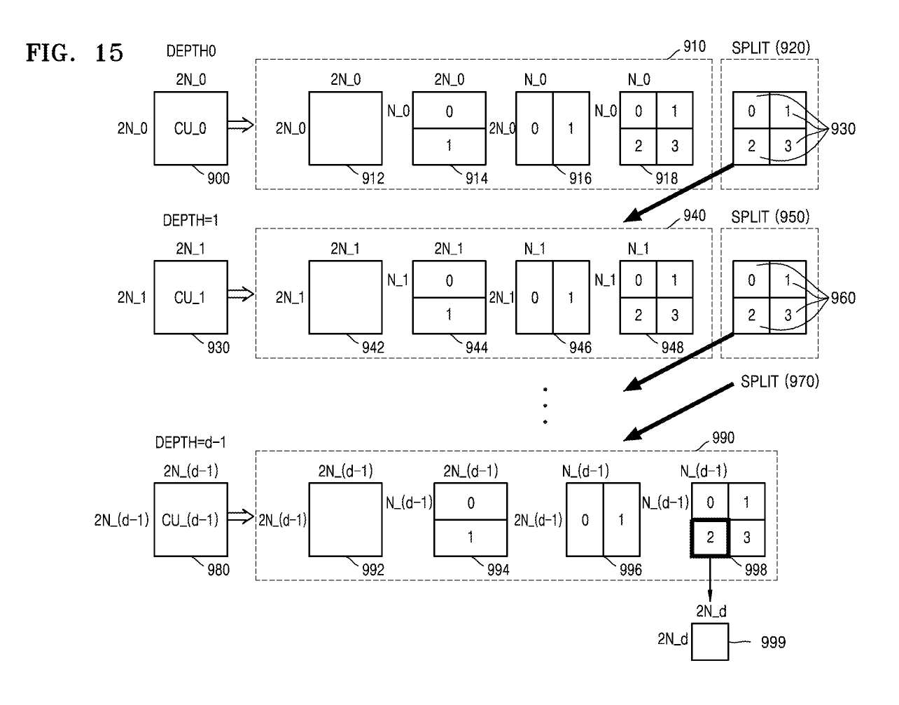

FIG. 15 is a diagram of deeper coding units according to depths, according to various embodiments.

Split information may be used to indicate a change of a depth. The spilt information indicates whether a coding unit of a current depth is split into coding units of a lower depth.

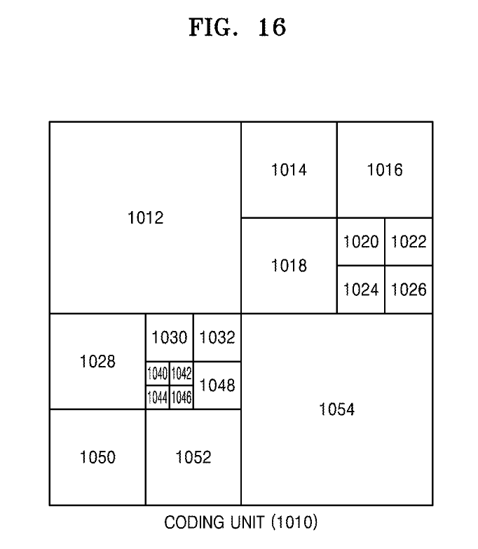

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 16 only illustrates the partitions 912 through 918 which are obtained by symmetrically splitting the prediction unit, but a partition mode is not limited thereto, and the partitions of the prediction unit may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 912, 914, and 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_0×N_0 to search for a least encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1×N_1, a partition mode 946 having a size of N_1×2N_1, and a partition mode 948 having a size of N_1×N_1.

If an encoding error is the smallest in the partition mode 948, a depth is changed from 1 to 2 to split the partition mode 948 in operation 950, and encoding is repeatedly performed on coding units 960, which have a depth of 2 and a size of N_2×N_2 to search for a least encoding error.

When a maximum depth is d, split operation according to each depth may be performed up to when a depth becomes d−1, and split information may be encoded as up to when a depth is one of 0 to d−2. That is, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes to search for a partition mode having a least encoding error.

Even when the partition mode 998 has the least encoding error, since a maximum depth is d, a coding unit CU_(d−1) having a depth of d−1 is no longer split to a lower depth, and a depth for the coding units constituting a current largest coding unit 900 is determined to be d−1 and a partition mode of the current largest coding unit 900 may be determined to be N_(d−1)×N_(d−1). Also, since the maximum depth is d, split information for a coding unit 952 having a depth of d−1 is not set.

A data unit 999 may be a ‘minimum unit’ for the current largest coding unit. A minimum unit according to an embodiment may be a square data unit obtained by splitting a smallest coding unit having a lowermost depth by 4. By performing the encoding repeatedly, the video encoding apparatus 100 according to an embodiment may select a depth having the least encoding error by comparing encoding errors according to depths of the coding unit 900 to determine a depth, and set a corresponding partition mode and a prediction mode as an encoding mode of the depth.

As such, the least encoding errors according to depths are compared in all of the depths of 1 through d, and a depth having the least encoding error may be determined as a d depth. The depth, the partition mode of the prediction unit, and the prediction mode may be encoded and transmitted as split information. Also, since a coding unit is split from a depth of 0 to a depth, only split information of the depth is set to 0, and split information of depths excluding the depth is set to 1.

The image data and encoding information extractor 220 of the video decoding apparatus 200 according to an embodiment may extract and use the information about the depth and the prediction unit of the coding unit 900 to decode the partition 912. The video decoding apparatus 200 according to an embodiment may determine a depth, in which split information is 0, as a depth by using split information according to depths, and use split information of the corresponding depth for decoding.

FIGS. 16, 17, and 18 are diagrams for describing a relationship between coding units, prediction units, and transformation units, according to various embodiments.

Coding units 1010 are coding units having a tree structure, according to depths determined by the video encoding apparatus 100 according to an embodiment, in a largest coding unit. Prediction units 1060 are partitions of prediction units of each of coding units according to depths, and transformation units 1070 are transformation units of each of coding units according to depths.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some coding units 1014, 1016, 1022, 1032, 1048, 1050, 1052, and 1054 are obtained by splitting the coding units in the coding units 1010. That is, partition modes in the coding units 1014, 1022, 1050, and 1054 have a size of 2N×N, partition modes in the coding units 1016, 1048, and 1052 have a size of N×2N, and a partition modes of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, 1052, and 1054 in the transformation units 1070 are data units different from those in the prediction units 1060 in terms of sizes and shapes. That is, the video encoding and decoding apparatuses 100 and 200 according to an embodiment may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, information about a partition mode, information about a prediction mode, and information about a size of a transformation unit. Table 1 shows the encoding information that may be set by the video encoding and decoding apparatuses 100 and 200 according to various embodiments.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction Mode | Partition Type | | Size of Transformation Unit | | Repeatedly |
| Intra Inter | Symmetrical | Asymmetrical | Split Information 0 of | Split Information 1 of | Encode Coding |
| Skip (Only | Partition Type | Partition Type | Transformation Unit | Transformation Unit | Units having |
| 2N × 2N) | 2N × 2N | 2N × nU | 2N × 2N | N × N | Lower Depth |
| | 2N × N | 2N × nD | | (Symmetrical Type) | of d + 1 |
| | N × 2N | nL × 2N | | N/2 × N/2 | |
| | N × N | nR × 2N | | (Asymmetrical Type) | |

The output unit 130 of the video encoding apparatus 100 according to an embodiment may output the encoding information about the coding units having a tree structure, and the image data and encoding information extractor 220 of the video decoding apparatus 200 according to an embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a depth, and thus information about a partition mode, prediction mode, and a size of a transformation unit may be defined for the depth. If the current coding unit is further split according to the split information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition type of the current coding unit is an asymmetrical partition mode, the size of the transformation unit may be N/2×N/2.

The encoding information about coding units having a tree structure, according to an embodiment, may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a largest coding unit may be determined.

Accordingly, if a current coding unit is predicted based on encoding information of adjacent data units, encoding information of data units in deeper coding units adjacent to the current coding unit may be directly referred to and used.

As another example, if a current coding unit is predicted based on encoding information of adjacent data units, data units adjacent to the current coding unit are searched using encoded information of the data units, and the searched adjacent coding units may be referred for predicting the current coding unit.

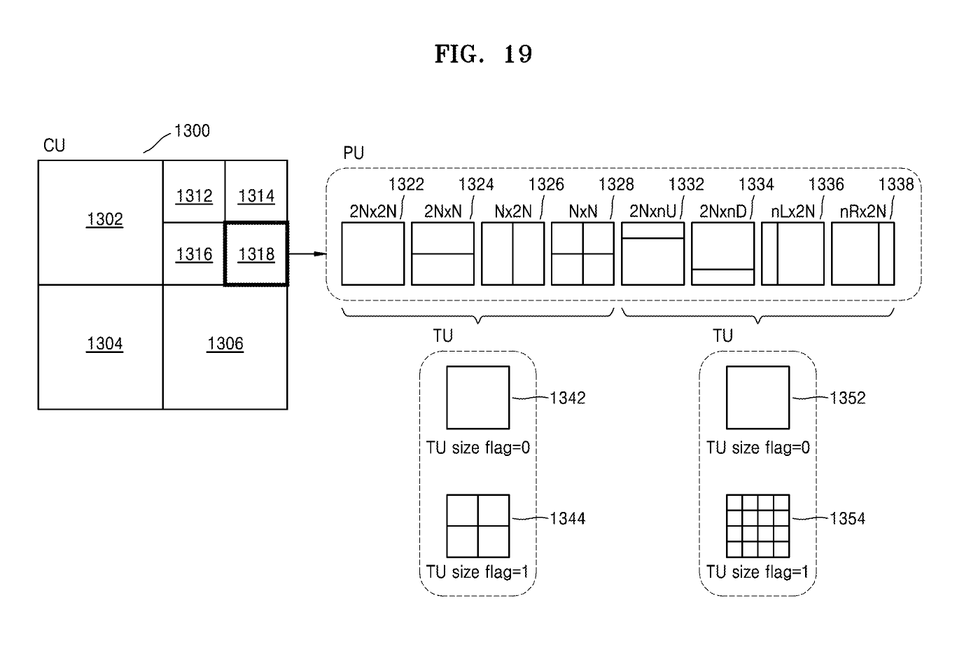

FIG. 19 is a diagram for describing a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Split information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1. Referring to FIG. 19, the TU size flag is a flag having a value or 0 or 1, but the TU size flag according to an embodiment is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to various embodiments, together with a maximum size and minimum size of the transformation unit. The video encoding apparatus 100 according to an embodiment is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 according to an embodiment may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present disclosure is not limited thereto.

According to the video encoding method based on coding units having a tree structure as described with reference to FIGS. 7 through 19, image data of a spatial region is encoded for each coding unit of a tree structure. According to the video decoding method based on coding units having a tree structure, decoding is performed for each largest coding unit to reconstruct image data of a spatial region. Thus, a picture and a video that is a picture sequence may be reconstructed. The reconstructed video may be reproduced by a reproducing apparatus, stored in a storage medium, or transmitted through a network.

The embodiments according to the present disclosure may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the depth image encoding method and/or the video encoding method described above with reference to FIGS. 1 through 19 will be collectively referred to as a ‘video encoding method of the present disclosure’. In addition, the depth image encoding method and/or the video decoding method described above with reference to FIGS. 1 through 19 will be referred to as a ‘video decoding method of the present disclosure’.

Also, a video encoding apparatus including the depth image encoding apparatus 40, the video encoding apparatus 100, or the image encoder 400, which has been described with reference to FIGS. 1 through 19, will be referred to as a ‘video encoding apparatus of the present disclosure’. In addition, a video decoding apparatus including the depth image decoding apparatus 30, the video decoding apparatus 200, or the image decoder 500, which has been descried with reference to FIGS. 1 through 19, will be collectively referred to as a ‘video decoding apparatus of the present disclosure’.

A computer-readable recording medium storing a program, e.g., a disc 26000, according to an embodiment will now be described in detail.

FIG. 20 is a diagram of a physical structure of the disc 26000 in which a program according to various embodiments is stored. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000 according to an embodiment, a program that executes the quantization parameter determining method, the video encoding method, and the video decoding method described above may be assigned and stored.

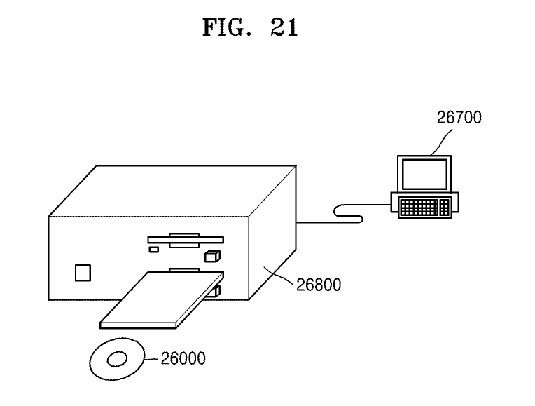

A computer system embodied using a storage medium that stores a program for executing the video encoding method and the video decoding method as described above will now be described with reference to FIG. 21.

FIG. 21 is a diagram of a disc drive 26800 for recording and reading a program by using the disc 26000. A computer system 27000 may store a program that executes at least one of a video encoding method and a video decoding method of the present disclosure, in the disc 26000 via the disc drive 26800. To run the program stored in the disc 26000 in the computer system 27000, the program may be read from the disc 26000 and be transmitted to the computer system 26700 by using the disc drive 27000.

The program that executes at least one of a video encoding method and a video decoding method of the present disclosure may be stored not only in the disc 26000 illustrated in FIGS. 20 and 21 but also in a memory card, a ROM cassette, or a solid state drive (SSD).

A system to which the video encoding method and a video decoding method described above are applied will be described below.

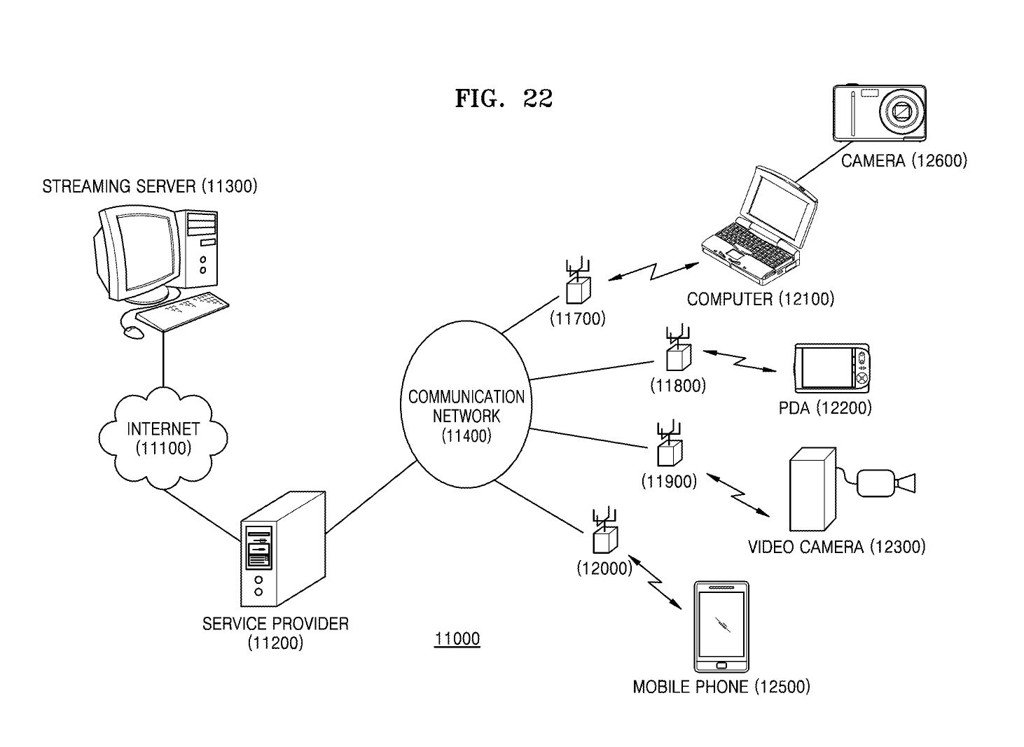

FIG. 22 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to the structure as illustrated in FIG. 22, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 according to an embodiment may encode content data recorded by a user using the video camera 12300, the camera 12600, the mobile phone 12500, or another imaging device, e.g., content recorded during a concert, and may transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and to decode and reproduce the encoded content data in real-time, thereby enabling personal broadcasting.

The video encoding apparatus and the video decoding apparatus of the present disclosure may be applied to encoding and decoding operations of the plurality of independent devices included in the content supply system 11000.

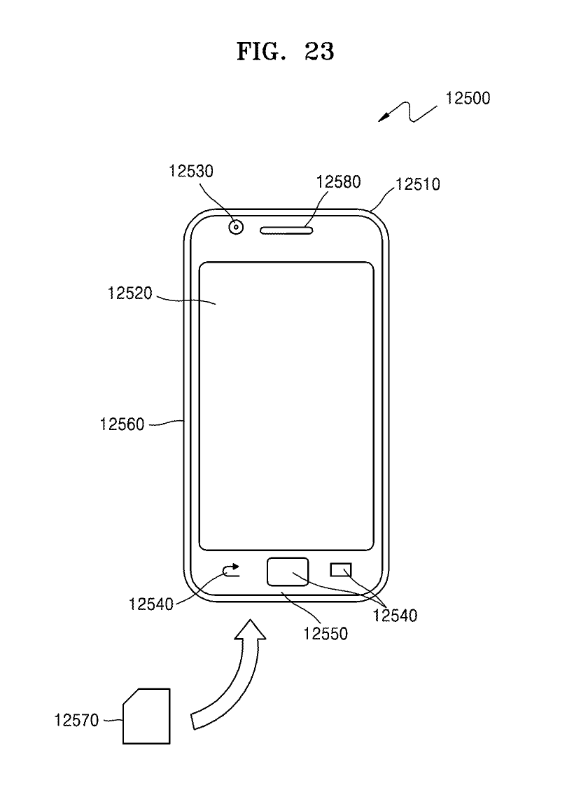

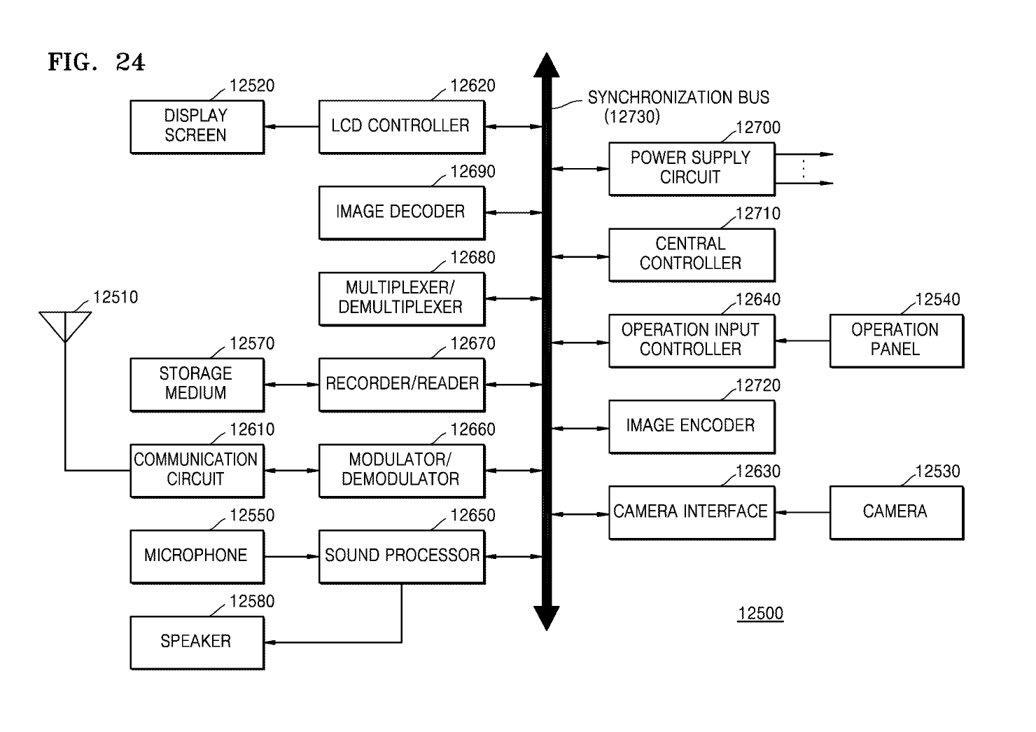

With reference to FIGS. 23 and 24, the mobile phone 12500 included in the content supply system 11000 according to an embodiment will now be described in greater detail.

FIG. 23 illustrates an external structure of the mobile phone 12500 to which the video encoding method and the video decoding method of the present disclosure are applied, according to various embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 24 illustrates an internal structure of the mobile phone 12500. In order to systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

In order to transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the video encoding apparatus 100 described above. The image encoder 12720 may transform the image data received from the camera 12530 into compressed and encoded image data according to the video encoding method described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from an external source, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the video decoding apparatus 200 described above. The image decoder 12690 may decode the encoded video data to obtain reconstructed video data and provide the reconstructed video data to the display screen 12520 via the LCD controller 12620, according to a video decoding method employed by the video decoding apparatus 200 or the image decoder 500 described above.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transceiving terminal including only the video encoding apparatus of the present disclosure, or may be a transceiving terminal including only the video decoding apparatus of the present disclosure.

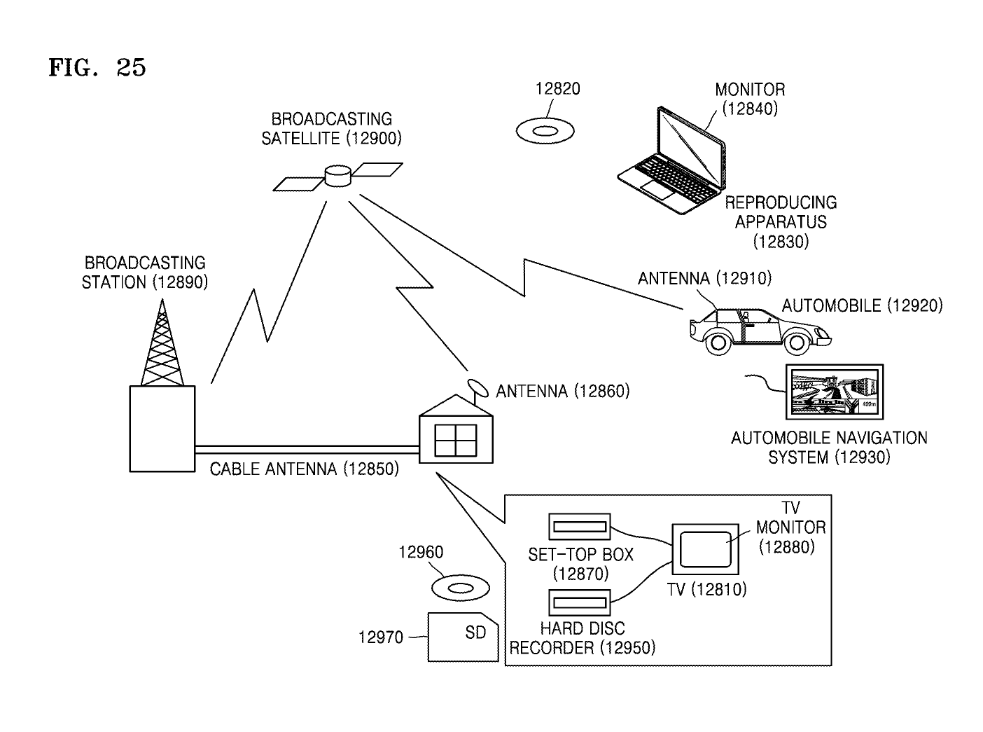

A communication system according to the present disclosure is not limited to the communication system described above with reference to FIG. 22. For example, FIG. 25 illustrates a digital broadcasting system employing a communication system, according to various embodiments. The digital broadcasting system of FIG. 25 according to an embodiment may receive a digital broadcast transmitted via a satellite or a terrestrial network by using the video encoding apparatus and the video decoding apparatus of the present disclosure.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by the video encoding apparatus of the present disclosure and may then be recorded to and stored in a storage medium. In more detail, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus of the present disclosure according to an embodiment, a video signal recorded on the DVD disc 12960, the SD card 12970, or another storage medium may be reproduced on the TV monitor 12880.

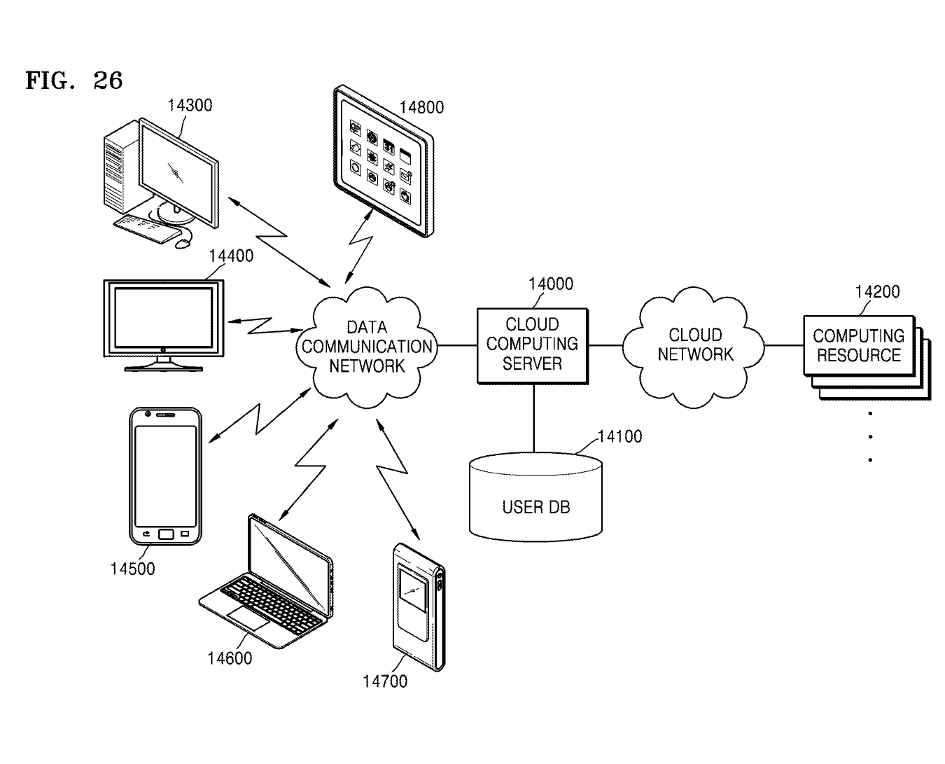

The automobile navigation system 12930 may not include the camera 12530, the camera interface 12630, and the image encoder 12720 of FIG. 26. For example, the computer 12100 and the TV receiver 12810 may not include the camera 12530, the camera interface 12630, and the image encoder 12720 of FIG. 26.

FIG. 26 is a diagram illustrating a network structure of a cloud computing system using a video encoding apparatus and a video decoding apparatus, according to various embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. On the other hand, if the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus of the present disclosure as described above with reference to FIGS. 1 through 19. As another example, the user terminal may include the video encoding apparatus of the present disclosure as described above with reference to FIGS. 1 through 19. Alternatively, the user terminal may include both the video decoding apparatus and the video encoding apparatus of the present disclosure as described above with reference to FIGS. 1 through 19.

Various applications of a video encoding method, a video decoding method, a video encoding apparatus, and a video decoding apparatus according to various embodiments described above with reference to FIGS. 1 through 19 have been described above with reference to FIGS. 20 through 26. However, methods of storing the video encoding method and the video decoding method in a storage medium or methods of implementing the video encoding apparatus and the video decoding apparatus in a device according to various embodiments described above with reference to FIGS. 1 through 19 are not limited to the embodiments described above with reference to FIGS. 20 through 26.

It will be understood by one of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

1. A depth image decoding method comprising:
obtaining, from a bitstream, a first flag comprising information about use of an intra contour mode related to intra prediction of a depth image;
determining whether to perform prediction in the intra contour mode on a prediction unit of the depth image, based on the first flag;
performing prediction in the intra contour mode on the prediction unit upon determining to perform prediction in the intra contour mode on the prediction unit; and
decoding the depth image based on a result of the performing of prediction.

2. The depth image decoding method of claim 1, wherein the first flag is comprised in a sequence parameter set extension comprising additional information for decoding the depth image.

3. The depth image decoding method of claim 1, further comprising:
reconstructing a color image based on coding information of the color image obtained from the bitstream;
splitting a largest coding unit of the depth image into at least one coding unit based on split information of the depth image;
determining whether to perform intra prediction on the coding unit; and
splitting the coding unit into the prediction unit for prediction decoding,
wherein the determining of whether to perform prediction in the intra contour mode comprises determining whether a slice type corresponding to the coding unit indicates an intra slice, and
wherein the intra slice indicated by the slice type comprises an enhanced intra slice allowing prediction on the depth image with reference to the color image.

4. The depth image decoding method of claim 3, wherein the performing of prediction comprises performing prediction on a prediction unit comprised in the enhanced intra slice, with reference to a block of the color image comprised in the same access unit as the depth image.

5. The depth image decoding method of claim 1, wherein the determining of whether to perform prediction in the intra contour mode comprises:
obtaining, from a bitstream, a third flag comprising information for determining whether to obtain a second flag comprising information about use of a depth intra mode; and
determining to perform prediction in the depth intra mode, if the third flag has a value 0.

6. The depth image decoding method of claim 5, wherein the performing of prediction comprises:
obtaining the second flag from the bitstream if the third flag has a value 0;
determining whether the second flag comprises information about the intra contour mode; and
performing prediction in the intra contour mode on the prediction unit, if the second flag comprises the information about the intra contour mode.

7. The depth image decoding method of claim 6, wherein the performing of prediction in the intra contour mode comprises:
referring to a block of the color image comprised in the same access unit as the depth image and provided at a location corresponding to the location of the prediction unit; and
performing prediction in the intra contour mode on the prediction unit based on a result of the referring.

8. A depth image encoding method comprising:
generating a first flag comprising information about use of an intra contour mode related to intra prediction of a depth image, among intra prediction modes;
determining whether to perform prediction in the intra contour mode on a prediction unit of the depth image, based on the first flag;
performing prediction in the intra contour mode on the prediction unit upon determining to perform prediction in the intra contour mode on the prediction unit; and
encoding the depth image based on a result of the performing of prediction.

9. The depth image encoding method of claim 8, wherein the first flag is comprised in a sequence parameter set extension comprising additional information for encoding the depth image.

10. The depth image encoding method of claim 8, further comprising:
generating a bitstream comprising coding information generated by encoding a color image;
splitting a largest coding unit of the depth image into at least one coding unit;
determining whether to perform intra prediction on the coding unit; and
splitting the coding unit into the prediction unit for prediction encoding,
wherein the determining of whether to perform prediction in the intra contour mode comprises determining whether a slice type corresponding to the prediction unit indicates an intra slice, and
wherein the intra slice indicated by the slice type comprises an enhanced intra slice allowing prediction with reference to the color image.

11. The depth image encoding method of claim 10, wherein the performing of prediction comprises performing prediction on a prediction unit of the depth image comprised in the enhanced intra slice, with reference to a block of the color image comprised in the same access unit as the depth image.

12. The depth image encoding method of claim 8, wherein the determining of whether to perform prediction in the intra contour mode comprises:
generating the bitstream comprising a third flag comprising information for determining whether to obtain a second flag comprising information about use of a depth intra contour prediction mode; and
determining to perform prediction in the depth intra contour prediction mode, if the third flag has a value 0.

13. The depth image encoding method of claim 12, wherein the performing of prediction comprises:
generating the bitstream comprising the second flag if the third flag has a value 0;
determining whether the second flag comprises information about the intra contour mode; and
performing prediction in the intra contour mode on the prediction unit, if the second flag comprises the information about the intra contour mode.

14. The depth image encoding method of claim 13, wherein the performing of prediction in the intra contour mode comprises:
referring to a block of the color image comprised in the same access unit as the depth image and provided at a location corresponding to the location of the prediction unit; and
performing prediction in the intra contour mode on the prediction unit based on a result of the referring.

15. A depth image decoding apparatus comprising:
a depth image prediction mode determiner for obtaining, from a bitstream, a first flag comprising information about use of an intra contour mode related to intra prediction of a depth image, and determining whether to perform prediction in the intra contour mode on a prediction unit of the depth image, based on the first flag; and
a depth image decoder for performing prediction in the intra contour mode on the depth image upon determining to perform prediction in the intra contour mode on the prediction unit, and decoding the depth image based on a result of the performing of prediction.

16. (canceled)

17. A non-transitory computer-readable recording medium having recorded thereon the depth image decoding method of claim 1.

18. A non-transitory computer-readable recording medium having recorded thereon the depth image encoding method of claim 8.
